(19) United States
(12) Patent Application Publication
(10) Pub. No.: US 2024/0058840 A1
(43) Pub. Date: Feb. 22, 2024

(54) DEPOSITION OF ETC MATERIALS ONTO SUBSTRATES VIA INKJET PRINTING

(71) Applicant: CORNING INCORPORATED, Corning, NY (US)

(72) Inventors: Philip Simon Brown, Big Flats, NY (US); Brandy Wright Fuller, Corning, NY (US); Charles Morrison Gardiner, Pittsford, NY (US); Mandakini Kanungo, Ithaca, NY (US); Carlo Anthony Kosik Williams, Painted Post, NY (US); Manoj Meda, Painted Post, NY (US)

(21) Appl. No.: 18/232,466

(22) Filed: Aug. 10, 2023

Related U.S. Application Data
(60) Provisional application No. 63/398,335, filed on Aug. 16, 2022.

(51) Int. Cl. B05D 5/08

(52) U.S. Cl. CPC B05D 5/083; G02B 1/18

(57) ABSTRACT

A coated article for use as a display screen for automotive displays includes a substrate that is a glass or a glass ceramic and has at least one surface, and an ETC coating bonded to the surface of the substrate by inkjet printing. A method for applying the ETC coating onto the substrate to produce the coated articles includes providing the substrate having the surface, where the substrate is a glass substrate or a glass ceramic substrate. The method further includes preparing an ETC coating composition that includes a polymer and a solvent. The viscosity of the ETC coating composition is from 2 cP to 30 cP. The method further includes inkjet printing the ETC coating composition onto the surface of the substrate and curing the ETC coating composition to produce the ETC coating. Inkjet printing increases the durability and uniformity of the ETC coating.

### CROSS-REFERENCE TO RELATED APPLICATIONS

This application claims the benefit of priority under 35 U.S.C. § 119 of U.S. Provisional Application Ser. No. 63/398,335 filed on Aug. 16, 2022, the content of which is relied upon and incorporated herein by reference in its entirety.

### BACKGROUND

### Field

The present disclosure generally relates to methods for producing coated articles, more specifically, to methods for depositing easy-to-clean (ETC) coatings onto glass or glass ceramic substrates to produce the coated articles.

### Technical Background

Glass and glass ceramics are commonly used for the primary user interface for touch screens and display screens for various electronic devices. Glass and glass ceramics are suitable for use as typing and swiping user interface screens due to the durability and optical properties of the glass and glass ceramics. Today, vehicle drivers place greater value on comfort, convenience, and connectivity in the vehicles that they operate. Not surprisingly, durable glass and glass ceramics with greater strength and premium optical clarity accompanied by thinner aspect ratios can help to provide this greater comfort, convenience, and connectivity while keeping automobile weights down to improve vehicle fuel economy. The glass and/or glass ceramics are often treated with various surface treatments to further improve the aesthetics, optical properties, durability, or other properties of the glass and/or glass ceramics. These glass treatments can include anti-reflective (AR) coatings, anti-glare coatings, anti-smudge and/or easy-to-clean coatings, or other types of surface treatments. Due to the longer service life of vehicles compared to personal electronic devices, the durability requirements of coatings applied to glass and glass ceramics for vehicle applications can be greater than the durability requirements for handheld personal electronic devices.

### SUMMARY

Currently, standard anti-fingerprint and easy-to-clean coatings struggle to meet durability requirements when applied in conjunction with other glass treatments and optical coatings. Accordingly, an ongoing need exists for easy-to-clean (ETC) coatings having greater durability and methods for producing the ETC coatings that provide greater flexibility in the configuration of the coated articles and/or greater flexibility in the manufacturing process.

The present application is directed to ETC coatings for glass and glass ceramic substrates for use in vehicle applications, such as but not limited to display screens, touch screens, instrument control panels, or other user interface devices and methods of applying the ETC coatings. The ETC coatings and methods disclosed herein provide ETC coatings with increased durability compared to existing ETC coatings, among other features.

According to a first aspect of the present disclosure, a method of applying an easy-to-clean (ETC) coating on a substrate can comprise providing the substrate having at least one surface, wherein the substrate comprises a glass substrate or glass ceramic substrate. The method can include preparing an ETC coating composition comprising at least one polymer and a solvent, wherein the viscosity of the ETC coating composition is from 2 cP to 30 cP. The method can include inkjet printing the ETC coating composition onto the at least one surface of the substrate and curing the ETC coating composition to produce the ETC coating.

A second aspect of the present disclosure may include the first aspect, wherein the at least one polymer of the ETC coating composition can comprise a fluorinated material with one or more silane moieties.

A third aspect of the present disclosure may include either one of the first or second aspects, wherein the at least one polymer of the ETC coating composition can comprise a silane functionalized perfluoropolyether.

A fourth aspect of the present disclosure may include any one of the first through third aspects, wherein the at least one polymer can comprise perfluoropolyether silane (Si-PFPE).

A fifth aspect of the present disclosure may include any one of the first through fourth aspects, wherein the ETC coating composition can comprise from 0.08 vol. % to 20 vol. % of the at least one polymer based on the total weight of the ETC coating composition.

A sixth aspect of the present disclosure may include any one of the first through fifth aspects, wherein the solvent can comprise one or more of a fluoroether solvent, a hydrofluoroether solvent, a perfluorocarbon solvent, a glycol, a glycol ether, a glycol ester, an alcohol, a hydrocarbon solvent, or combinations of these.

A seventh aspect of the present disclosure may include any one of the first through sixth aspects, wherein the solvent can comprise a perfluorocarbon solvent.

An eighth aspect of the present disclosure may include any one of the first through seventh aspects, wherein the solvent can comprise a fluoroether solvent.

A ninth aspect of the present disclosure may include any one of the first through eighth aspects, wherein the solvent can have a viscosity of from 1.2 cP to 24 cP.

A tenth aspect of the present disclosure may include any one of the first through ninth aspects, wherein the solvent can comprise a plurality of different solvents, each of the solvents having a different viscosity, wherein the ETC coating composition comprising the plurality of different solvents can have a viscosity of from 4 cP to 24 cP.

An eleventh aspect of the present disclosure may include any one of the first through tenth aspects, wherein the ETC coating composition can have a viscosity of from 4 cP to 18 cP.

A twelfth aspect of the present disclosure may include any one of the first through eleventh aspects, wherein the substrate can comprise a bare glass or glass ceramic substrate, a textured glass, a textured glass ceramic, or a glass or glass ceramic substrate having an optical coating applied to the at least one surface.

A thirteenth aspect of the present disclosure may include any one of the first through twelfth aspects, wherein the at least one surface can be a bare or textured surface of the substrate or wherein the at least one surface comprises an outer surface of an optical coating applied to the substrate.

A fourteenth aspect of the present disclosure may include any one of the first through thirteenth aspects, wherein the substrate can be a continuous ribbon of glass or glass ceramic.

A fifteenth aspect of the present disclosure may include the fourteenth aspect, further comprising, after curing the ETC coating, cutting the continuous ribbon of glass or glass ceramic into individual articles.

A sixteenth aspect of the present disclosure may include any one of the first through fifteenth aspects, wherein the ETC coating composition can comprise a viscosity modifier.

A seventeenth aspect of the present disclosure may include the sixteenth aspect, wherein the viscosity modifier can comprise a non-functionalized perfluoropolyether (PFPE).

Eighteenth aspect of the present disclosure may include the seventeenth aspect, wherein the non-functionalized PFPE can have an average molecular weight of from 1500 grams per mole to 2200 grams per mole.

A nineteenth aspect of the present disclosure may include any one of the sixteenth through eighteenth aspects, wherein the ETC coating composition can comprise from 1 vol. % to 50 vol. % viscosity modifier based on the total volume of the ETC coating composition.

A twentieth aspect of the present disclosure may include any one of the first through nineteenth aspects, wherein the ETC coating can exhibit a water contact angle of greater than or equal to 100 degrees after abrading the surface of the ETC coating with cheesecloth for 200,000 cycles.

A twenty-first aspect of the present disclosure may include any one of the first through twentieth aspects, wherein the ETC coating can exhibit a static water contact angle of greater than 110 degrees immediately following curing.

A twenty-second aspect of the present disclosure may include any one of the first through twenty-first aspects, wherein the ETC coating can have a thickness of from 2 nm to 10 nm.

A twenty-third aspect of the present disclosure may include any one of the first through twenty-second aspects, further comprising, after the curing, wiping the ETC coating.

A twenty-fourth aspect of the present disclosure may include any one of the first through twenty-third aspects, comprising inkjet printing the ETC coating composition onto the at least one surface of the substrate with an inkjet printing system.

A twenty-fifth aspect of the present disclosure may include any one of the first through twenty-sixth aspects, wherein inkjet printing the ETC coating composition can comprise successively depositing a plurality of individual droplets onto the at least one surface of the substrate, wherein an average size of the plurality of individual droplets can be from 2 pL to 100 pL.

A twenty-sixth aspect of the present disclosure may include any one of the first through twenty-fifth aspects, wherein the droplet volume of 99% of the plurality of individual droplets can be within 5% of the average droplet volume of the plurality of individual droplets.

A twenty-seventh aspect of the present disclosure may include any one of the first through twenty sixth aspects, comprising inkjet printing the ETC coating composition with a resolution of from 150 dpi to 2400 dpi.

A twenty-eighth aspect of the present disclosure may include any one of the first through twenty-seventh aspects, comprising inkjet printing the ETC coating composition at different resolutions in different regions of the at least one surface of the substrate.

A twenty-ninth aspect of the present disclosure may include any one of the first through twenty-eighth aspects, comprising changing a thickness of the ETC coating in one or more regions of the at least one surface of the substrate.

A thirtieth aspect of the present disclosure may include the twenty-ninth aspect, wherein changing the thickness of the ETC coating can comprise one or more of the following: modifying an average droplet size of the plurality of individual droplets of the ETC coating composition; modifying a resolution (pixels per inch) of the inkjet printing; modifying a number of individual droplets of the ETC coating composition printed per pixel; inkjet printing one or more subsequent layers of the ETC coating compositions; or combinations of these.

A thirty-first aspect of the present disclosure may include either one of the twenty-ninth or thirtieth aspects, comprising: inkjet printing the ETC coating composition in a first region of the at least one surface of the substrate to produce the ETC coating in the first region having a first thickness; and inkjet printing the ETC coating composition in a second region of the at least one surface of the substrate to produce the ETC coating in the second region having a second thickness, wherein the second thickness is different from the first thickness.

A thirty-second aspect of the present disclosure may include any one of the first through thirty-first aspects, comprising: inkjet printing a plurality of individual droplets of the ETC coating composition onto the at least one surface of the substrate, wherein the individual droplets can be separated from one another by uncoated regions of the at least one surface of the substrate; and curing the plurality of individual droplets, wherein curing the plurality of individual droplets can produce a plurality of individual dots of the ETC coating separated from one another by the uncoated regions of the at least one surface of the substrate.

A thirty-third aspect of the present disclosure may include any one of the first through thirty-second aspects, comprising modifying a coefficient of friction of the at least one surface of the substrate by changing a print resolution, an average droplet volume, a number of droplets of the ETC coating composition per pixel, or combinations of these of the inkjet printing process.

A thirty-fourth aspect of the present disclosure may include any one of the first through thirty-third aspects, comprising modifying a water contact angle of the at least one surface of the substrate by changing a print resolution, an average droplet volume, a number of droplets of the ETC coating composition per pixel, or combinations of these of the inkjet printing process.

A thirty-fifth aspect of the present disclosure may include any one of the first through thirty-fourth aspects, wherein inkjet printing the ETC coating composition on a first surface of the substrate does not result in deposition of the ETC coating composition on a second surface of the substrate.

A thirty-sixth aspect of the present disclosure may include any one of the first through thirty-fifth aspects, comprising inkjet printing the ETC coating composition on a first side of the substrate and inkjet printing the ETC coating composition, a decorative ink, or both on a second side of the substrate, wherein inkjet printing the ETC coating composition, the decorative ink, or both on the second side of the substrate can be performed after or during inkjet printing the ETC coating composition on the first side.

A thirty-seventh aspect of the present disclosure may include the thirty-sixth aspect, comprising inkjet printing the decorative ink composition on the second side of the substrate after or during inkjet printing the ETC coating composition on the first side of the substrate.

A thirty-eighth aspect of the present disclosure may include any one of the first through thirty-seventh aspects, comprising curing the ETC coating composition at a cure temperature and cure time of from ambient temperature for 24 hours to 200° C. for 30 minutes.

A thirty-ninth aspect of the present disclosure may include any one of the first through thirty-eighth aspects, further comprising ion exchanging the substrate before inkjet printing the ETC coating composition onto the at least one surface of the substrate.

A fortieth aspect of the present disclosure may include any one of the first through thirty-ninth aspects, further comprising applying an optical coating to the at least one surface of the substrate before inkjet printing the ETC coating composition onto the at least one surface of the glass substrate.

A forty-first aspect of the present disclosure may include any one of the first through fortieth aspects, further comprising cutting the substrate into a plurality of articles comprising at least a portion of the substrate with the ETC coating on the at least one surface of the substrate after curing the ETC coating composition to produce the ETC coating bonded to the at least one surface of the substrate.

A forty-second aspect of the present disclosure may include any one of the first through forty-first aspects, further comprising, after curing the ETC coating composition to produce the ETC coating, inkjet printing one or more supplemental coatings onto an outer surface of the ETC coating.

A forty-third aspect of the present disclosure is directed to a coated article comprising a substrate comprising a glass or a glass ceramic and having at least one surface, and an ETC coating bonded to the at least one surface of the substrate, wherein the ETC coating comprises a plurality of cured droplets of an ETC coating composition deposited onto the at least one surface of the substrate by inkjet printing.

A forty-fourth aspect of the present disclosure may include the forty-third aspect, wherein a tolerance of a thickness of the ETC coating can be less than or equal to 5% of an average thickness of a region of ETC coating, where the tolerance is the absolute value of the difference between the thickness and the average thickness divided by the average thickness multiplied by 100.

A forty-fifth aspect of the present disclosure may include the forty-fourth aspect, wherein, over a 50 mm by 50 mm square of the ETC coating over which the average thickness is calculated, the ETC coating can have an average static water contact angle of greater than 100 degrees with a tolerance of less than or equal to +/−4 degrees.

A forty-sixth aspect of the present disclosure may include any one of the forty-third through forty-fifth aspects, wherein the substrate can comprise an optical coating applied to the at least one surface of the substrate, and the ETC coating is bonded to an outer surface of the optical coating.

A forty-seventh aspect of the present disclosure may include any one of the forty-third through forty-sixth aspects, wherein the substrate can be ion exchanged, wherein the ion-exchange is performed prior to applying the ETC coating.

A forty-eighth aspect of the present disclosure may include any one of the forty-third through forty-seventh aspects, wherein the coated article can comprise one or more first regions comprising a first thickness of the ETC coating, and one or more second regions comprising a second thickness of the ETC coating, wherein the second thickness can be different from the first thickness.

A forty-ninth aspect of the present disclosure may include the forty-eighth aspect, wherein the first thickness of the ETC coating in 99% of the one or more first regions can be within 5% of an average first thickness of the one or more first regions; and the second thickness of the ETC coating in 99% of the one or more second regions can be within 5% of an average second thickness of the one or more second regions.

A fiftieth aspect of the present disclosure may include any one of the forty-third through forty-ninth aspects, comprising one or more uncoated regions of the substrate, wherein uncoated regions of the substrate refer to regions of the substrate having no ETC coating bonded to the at least one surface of the substrate or to an outer surface of an optical coating applied to the at least one surface of the substrate.

A fifty-first aspect of the present disclosure may include the fiftieth aspect, wherein an edge of the ETC coating can be spaced apart from a peripheral edge of the substrate to form a band of uncoated substrate proximate the peripheral edge of the substrate.

A fifty-second aspect of the present disclosure may include either one of the fiftieth or fifty-first aspects, wherein the ETC coating can comprise a plurality of regions of the ETC coating spaced apart from each other by uncoated regions of the substrate.

A fifty-third aspect of the present disclosure may include the fifty-second aspect, wherein the plurality of regions of the ETC coating and the plurality of the uncoated regions of the surface of the substrate can form a pattern.

A fifty-fourth aspect of the present disclosure may include any one of the fiftieth through fifty-third aspects, comprising a plurality of individual dots of the ETC coating separated by uncoated regions of the substrate.

A fifty-fifth aspect of the present disclosure may include any one of the forty-third through fifty-fourth aspects, wherein the at least one surface of the coated article can have a coefficient of friction of 0.6 to 0.08.

A fifty-sixth aspect of the present disclosure may include any one of the forty-third through fifty-fifth aspects, wherein the at least one surface of the coated article can have an average water contact angle of from 50 degrees to 120 degrees.

A fifty-seventh aspect of the present disclosure may include any one of the forty-third through fifty-sixth aspects, wherein the coated article can comprise a screen for one or more user interfaces of an electronic device.

A forty-eighth aspect of the present disclosure may include any one of the forty-third through fifty-seventh aspects, wherein the coated article can comprise a display or touch screen for an instrument panel, an infotainment system, or both for a vehicle.

A fifty-ninth aspect of the present disclosure may include any one of the forty-third through forty-eighth aspects, wherein the coated article can be a touch screen for an electronic device.

Additional features and advantages of the ETC coatings and the methods of depositing the ETC coatings described herein will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a coated article for a vehicle dashboard, according to one or more embodiments shown and described herein;

FIG. 2 schematically depicts a cross-sectional view of the coated article of FIG. 1, according to one or more embodiments shown and described herein;

FIG. 3 graphically depicts viscosity (y-axis) as a function of a volume ratio between two different solvents (top and bottom x-axis) for a two solvent system comprising a first solvent with a viscosity of 4.1 cP and a second solvent having a viscosity of 18 cP, according to one or more embodiments shown and described herein;

FIG. 4 graphically depicts viscosity (y-axis) as a function of concentration of a viscosity modifier (x-axis) for a mixture of a solvent and viscosity modifier comprising FOMBLIN® PFPE oil, according to one or more embodiments shown and described herein;

FIG. 5 schematically depicts a top view of an inkjet printing system, according to one or more embodiments shown and described herein;

FIG. 6 schematically depicts a side view, in partial cross section, of the inkjet printing system of FIG. 5, according to one or more embodiments shown and described herein;

FIG. 7 graphically depicts a total volume of ETC coating composition per pixel (y-axis) as a function of the number of individual droplets of the ETC coating composition per pixel (x-axis), according to one or more embodiments shown and described herein;

FIG. 8 schematically depicts an embodiment of a coated article having regions with different thicknesses of the ETC coating, according to one or more embodiments shown and described herein;

FIG. 9 depicts a flow chart for making a coated article through inkjet printing the ETC coating, according to one or more embodiments shown and described herein;

FIG. 10 depicts a flow chart for a process for making a coated article, according to the prior art;

FIG. 11 is a microphotograph of individual dots of the ETC coating composition printed in Example 1, according to one or more embodiments shown and described herein;

FIG. 12 graphically depicts a static water contact angle map for a 50×50 mm square of the ETC coating inkjet printed on a substrate at a print resolution of 150 dots per inch (dpi), according to one or more embodiments shown and described herein;

FIG. 13 graphically depicts a static water contact angle map for a 50×50 mm square of the ETC coating inkjet printed on a substrate at a print resolution of 300 dpi, according to one or more embodiments shown and described herein;

FIG. 14 graphically depicts a static water contact angle map for a 50×50 mm square of the ETC coating inkjet printed on a substrate at a print resolution of 600 dpi, according to one or more embodiments shown and described herein;

FIG. 15 graphically depicts a static water contact angle map for a 50×50 mm square of the ETC coating inkjet printed on a substrate at a print resolution of 900 dpi, according to one or more embodiments shown and described herein;

FIG. 16 graphically depicts a static water contact angle map for a 50×50 mm square of the ETC coating inkjet printed on a substrate at a print resolution of 1200 dpi, according to one or more embodiments shown and described herein;

FIG. 17 graphically depicts a static water contact angle map for a 50×50 mm square of the ETC coating inkjet printed on a substrate at a print resolution of 1800 dpi, according to one or more embodiments shown and described herein;

FIG. 18 graphically depicts static water contact angle (y-axis) as a function of inkjet printing resolution (dpi—x-axis) for coated articles prepared at different inkjet print resolutions, according to one or more embodiments shown and described herein;

FIG. 19 graphically depicts static water contact angle (y-axis) as a function of inkjet print resolution (dpi—x-axis) for abraded and non-abraded samples of coated articles prepared through inkjet printing compared to comparative coated articles prepared through spray coating, according to one or more embodiments shown and described herein;

FIG. 20 graphically depicts droplet velocity (y-axis) as a function of voltage (x-axis) for an inkjet printing process for printing an ETC coating composition, according to one or more embodiments shown and described herein;

FIG. 21 graphically depicts droplet velocity (y-axis) as a function of droplet frequency (x-axis) for an inkjet printing process for printing an ETC coating composition, according to one or more embodiments shown and described herein;

FIG. 22 schematically depicts a perspective view of a coated article comprising an ETC coating and an uncoated band extending around the peripheral edges of the coated article, according to one or more embodiments shown and described herein;

FIG. 23 schematically depicts a perspective view of a coated article comprising an ETC coating produce by printing a pattern of regions of the ETC coating composition separated from each other by uncoated regions of a surface of the substrate, according to one or more embodiments shown and described herein;

FIG. 24 schematically depicts a perspective view of a coated article comprising individual dots of an ETC coating inkjet printed onto a surface of a substrate and separated by uncoated regions, according to one or more embodiments shown and described herein;

FIG. 25 graphically depicts static water contact angle (left y-axis) and coefficient of friction (CoF) (right y-axis) as a function of print resolution (x-axis) for coated articles inkjet printed at various print resolutions, according to one or more embodiments shown and described herein;

FIG. 26 graphically depicts an amount of ETC coating composition applied (y-axis) as a function of print resolution (x-axis) for coated articles printed with different grey levels, according to one or more embodiments shown and described herein;

FIG. 27 graphically depicts a static water contact angle (y-axis) as a function of print resolution (x-axis) for coated articles before and after cheesecloth abrasion for 200,000 abrasion cycles, according to one or more embodiments shown and described herein; and

FIG. 28 graphically depicts static water contact angle (y-axis) as a function of print resolution (x-axis) for coated articles prepared with printheads having different average droplet volumes, according to one or more embodiments shown and described herein.

### DETAILED DESCRIPTION

Reference will now be made in detail to various embodiments of the ETC coatings and methods of applying the ETC coatings to a substrate. Examples of the ETC coatings and methods disclosed herein are schematically depicted in the accompanying drawings. Whenever possible, the same reference numerals will be used throughout the drawings to refer to the same or like parts.

Referring now to FIG. 2, a coated article 100 disclosed herein may include a substrate 110 comprising a glass or a glass ceramic and having at least one surface 112, and an ETC coating 130 bonded to the at least one surface 112 of the substrate 110 by inkjet printing. A method for applying the ETC coating 120 on the substrate 110 to produce the coated articles 100 may include providing the substrate 110 having the at least one surface 112, wherein the substrate 110 comprises a glass substrate or glass ceramic substrate. The method may further include preparing an ETC coating composition comprising at least one polymer and a solvent, wherein the viscosity of the ETC coating composition is from 2 cP to 30 cP. The method may further include inkjet printing the ETC coating composition onto the at least one surface 112 of the substrate 110 and curing the ETC coating composition to produce the ETC coating 120.

Various embodiments of the ETC coatings and the methods of applying the ETC coatings will be described herein with specific reference to the appended drawings.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the terms “upstream” and “downstream” refer to the positioning of manufacturing steps relative to progress of the substrate through the process. A manufacturing step is considered “downstream” of a second manufacturing step if the substrate encounters the second manufacturing step before encountering the first manufacturing step. Likewise, the first manufacturing step is considered “upstream” of the second manufacturing step if the substrate encounters the first manufacturing step before encountering the second manufacturing step.

As used herein, the “A-side” of a substrate refers to the side of the substrate facing outward toward the user and provides the surface for interaction with the user. As used herein, the “B-side” of a substrate refers to the side of the substrate facing away from the user and towards the other electronic components of the display or other electronic device.

As used herein, the term “substantially free” of a constituent may refer to a composition, layer, or atmosphere that includes less than 0.01 percent by weight or by mole of the constituent.

As used herein, the terms “micrometers,” “microns,” and “μm” are used interchangeably. The terms “nanometers” and “nm” are used interchangeably herein.

As used herein, the term “easy-to-clean coating” or “ETC coating” refers to a coating comprising polymer and having a water contact angle of greater than 100 degrees when applied as an even coating covering a surface of a substrate. Example ETC coatings can include fluorinated materials (e.g., PFPE) and non-fluorinated materials (e.g., octadecyltrimethoxysilane).

As used herein, the term “ETC coating composition” is used to refer to the mixture comprising at least a polymer and a solvent prepared for inkjet printing onto the substrate and prior to curing. Thus, the ETC coating composition includes the solvent as well as the polymer. As used herein, the term “ETC coating” is used to refer to the coating after curing, where the polymer is anchored to the glass with a silane group.

As used herein, the terms “dots” and “pixels” are used interchangeably and refer to the collection of specific positions on the surface of the substrate at which an inkjet printhead deposits at least one droplet of the ETC coating composition. Throughout the application, print resolution is expressed in units of dots per inch (dpi), which should be understood to be the same as pixels per inch (ppi).

As used herein, the term “grey scale” refers to a number of multiple pulses in a waveform used by the control system of the inkjet printing system to operate and control the printhead. The multiple pulses of the waveform cause the printhead to jet a plurality of droplets of the ETC coating composition in rapid succession at each pixel such that the plurality of droplets coalesce to form a single droplet. The size of the single droplet can depend on the number of pulses in the waveform (e.g., number of droplets jetted by the printhead).

Vehicle drivers place greater value on comfort, convenience, and connectivity in the vehicles that they operate. Thus, vehicles can include various user interface devices, such as but not limited to displays, touchscreens, buttons, infotainment systems, and other user interface devices incorporated into the vehicle. These user interface devices and other articles are commonly constructed of glass and/or glass ceramics, which can provide greater strength and premium optical clarity accompanied by thinner aspect ratios. The glass and/or glass ceramic articles are often treated with various surface treatments to further improve the aesthetics, optical properties, durability, or other properties of the glass and/or glass ceramic articles. These glass treatments can include anti-reflective (AR) coatings and anti-glare coatings to modify and improve the optical properties of the glass or glass ceramic articles. The glass treatments can also include surface aesthetic coatings, such as anti-smudge coatings or easy-to-clean (ETC) coatings, to aid in maintaining a good appearance of the outer surface of the article during use. Other types of surface treatments can be applied to the glass or glass ceramic articles. Due to the longer service life of vehicles compared to personal electronic devices, the durability requirements of coatings applied to glass and glass ceramic articles for vehicle applications can be more stringent compared to the durability requirements for handheld personal electronic devices.

Coatings for improving the aesthetics of the glass or glass ceramic articles can include anti-smudge coatings and/or easy-to-clean (ETC) coatings. Material choices for these surface aesthetic coatings (e.g., anti-smudge or ETC coatings) are limited due to requirement for these materials to repel a variety of substances, such as but not limited to water, dust, environmental debris, and sebum (e.g., including oils and proteins), from the surface of the glass or glass ceramic. The surface must retain its performance, not only with respect to repelling debris and contaminants, but also with repeated abrasion resulting from swiping or touching during use or cleaning to remove substances from the surface. Fluorinated materials with silane moieties are common for these applications and are typically covalently bound to the surface for longevity. Silanes typically bind to the surface as monolayers, but the surface aesthetic coatings can be multilayer structures depending on the coating and surface chemistry. ETC coatings comprising silane-functionalized fluorinated polymers can provide good performance for repelling water, dust, environmental debris, sebum, and other materials. However, once the nano-thickness of the surface aesthetic coating is abraded away, the surface of the glass or glass ceramic article no longer retains the desired repellent properties.

The current durability requirement for coatings applied to glass or glass ceramic articles for vehicle applications is determined by cheesecloth abrasion with 200,000 cycles, according to the method disclosed herein. For example, in certain instances, it may be desirable for a surface aesthetic coating to exhibit a water contact angle greater than or equal to 100 degrees after the 200,000 cycles of abrasion with cheesecloth. Currently, standard anti-smudge coatings and/or ETC coatings struggle to meet this requirement when applied in conjunction with other glass treatments for improving optical performance (e.g., AR coatings or anti-glare coatings).

For many handheld electronic devices, such as cell phones, tablets, or other personal electronics, surface aesthetic coatings, such as but not limited to anti-smudge, ETC coatings, or both, can be applied by a physical vapor deposition (PVD) process. The PVD process can produce an anti-smudge coating or ETC coating with good durability. However, the PVD process requires specialized equipment and materials for accomplishing deposition of the coating, which result in high capital and operating costs for the PVD process. The glass and glass ceramic articles for vehicle applications are much larger compared to the screens for handheld personal electronic devices, which makes PVD processes for applying the surface aesthetic coatings uneconomical for vehicle display applications.

For vehicle display applications, surface aesthetic coatings are typically applied by spray coating the glass and/or glass ceramic articles and then curing the sprayed-on coating. The spray coating process is more cost effective compared to PVD coatings, but is highly inefficient. In particular, the spray coating process for applying ETC coatings is a turbulent process that can result in significant overspray onto the B-side of the glass or glass ceramic article and also onto the carrier plate, which is the plate that supports the glass or glass ceramic substrate and carries the substrate through the spray coating operation. B-side contamination is undesirable as it can affect customer's downstream processes, and the more ETC left on the carrier plate the more cleaning is required before the carrier plate can be reused in the spray coating process. Additionally, the fluorinated polymer materials and the solvents required for spray coating applications are expensive, as is the necessary abatement required on the exhaust of the spray coating tool to remove the fluorinated polymer and solvents from the spray exhaust. Further, the current spray coating process for applying ETC coatings applies the ETC coating over the entire surface of the glass or glass ceramic article. Patterning can only be accomplished with complex, expensive, and time-consuming masking procedures.

The present application is directed to ETC coatings and methods for applying the ETC coatings to a substrate through an inkjet printing process. Coated articles comprising glass and/or glass ceramic substrates coated with the ETC coatings are also disclosed and can be used for vehicle display applications. The methods disclosed herein for applying an ETC coating on a substrate include providing the substrate having at least one surface. The substrate can be a glass substrate or glass ceramic substrate. The methods disclosed herein can further include preparing the ETC coating composition that can include at least one polymer and a solvent, where the viscosity of the ETC coating composition is from 2 cP to 30 cP. The viscosity can be determined according to the test method provided herein. The methods disclosed herein can further include inkjet printing the ETC coating composition onto the at least one surface of the substrate and curing the ETC coating composition to produce the ETC coating on the substrate.

The result of the inkjet printing process of the present disclosure is the coated article comprising the substrate, such as a glass substrate or a glass ceramic substrate, having at least one surface and the ETC coating applied onto at least a portion of the at least one surface of the substrate. The ETC coating produced through the inkjet printing process can have a more uniform thickness and can exhibit a static water contact angle—after cheesecloth abrading—that is more uniform across the surface of the coated article compared to that of a spray coated ETC coating.

The inkjet printing process for inkjet printing the ETC coatings can have substantially lower capital and operating costs compared to PVD processes. Compared to spray ETC coating applications, the methods disclosed herein for inkjet printing the ETC coating provide improved material utilization by utilizing less material to coat same square footage. Further, less processing and costs are required for abatement of the vapors from the methods of inkjet printing compared to spray coating, due to less solvent transport in the exhaust compared to spray coating. The method disclosed herein for inkjet printing the ETC coatings onto the substrate can reduce and/or prevent overspray onto the B-side of the part, the carrier plate, or both. Reducing or eliminating overspray onto the carrier plate can reduce the need to clean the plates before they are reused in the process.

The methods disclosed herein of inkjet printing the ETC coatings can provide the ability to print patterns of the ETC coating, which can enable varying the amount of ETC coating printed across a part, leading to improved material utilization. The inkjet printing method can also enable the amount of the ETC coating to be increased in high-touch areas such as the touch screen display or controls to improve durability or to change the tactile feel in designated areas, such as but not limited to buttons or other control features. The ability to pattern with the methods disclosed herein can also enable inkjet printing of the ETC coating only up to a certain distance from the edge of the part, which can practically eliminate contamination of the B-side with the ETC coating. The methods disclosed herein for inkjet printing the ETC coating can also improve process flexibility by enabling different orders of process steps or alterative orientation of the coating process (e.g., ability to coat vertically or horizontally), among other features.

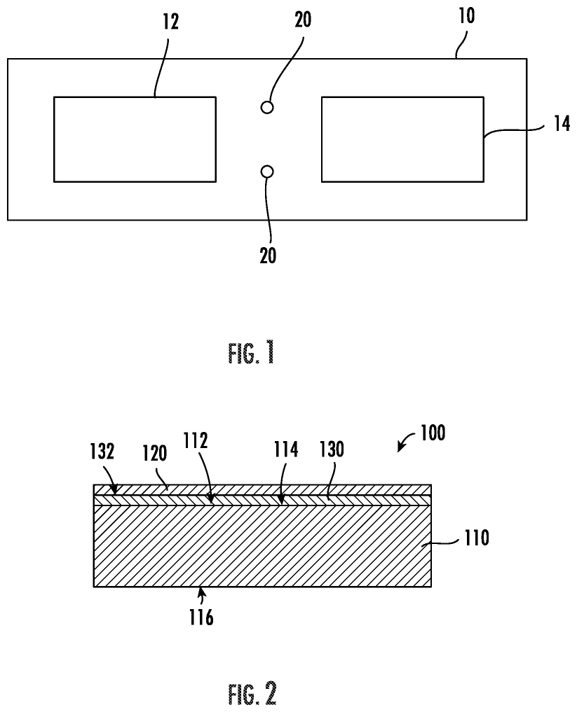

As discussed above, the methods disclosed herein for inkjet printing the ETC coatings can enable variations in the amount of the ETC coating deposited on different areas of the surface of an article. Referring now to FIG. 1, one embodiment of an article 10 for use as part of a control panel for a vehicle is schematically depicted. As shown in FIG. 1, in embodiments, the article 10 can have a first display area 12, a second display area 14, and a plurality of buttons 20. The first display area 12 can be a display oriented behind the steering wheel of the vehicle. In embodiments, the primary function of the first display area 12 behind the steering wheel can be to display information to the operator of the vehicle, and may not include much touch screen interaction with the operator. Because of the minimal interaction with the operator, the amount of the ETC coating in the first display area 12 can be reduced, due to fewer touch events, which requires less performance from the ETC coatings. The second display area 14 can be located proximate to the center of the vehicle dashboard and can be part of a user interface or infotainment system requiring a greater degree of touch interaction between the operator of the vehicle or passenger and the second display area 14. Due to the greater touch interaction with the operator or passenger, the second display area 14 can have a greater amount of the ETC coating applied to increase the performance and durability of the ETC coating in these regions to handle the greater number of touch events and cleaning events. Additionally, the buttons 20 may also have a greater amount of ETC coating compared to the first display area 12 to account for the greater number of touch events. Further, buttons 20 can be printed with a textured pattern to make it easier for the operator to find the buttons 20 by feel rather than by diverting vision from operation of the vehicle to the control panel. Finally, areas of the article 10 that do not have touch screens 12,14 or buttons 20 can have reduced amounts of ETC coatings due to the fewer touch events expected for these areas.

Referring now to FIG. 2, a cross-sectional view of one embodiment of the article 100 is schematically depicted. The article 100 comprises a substrate 110 and an ETC coating 120 applied to at least one surface 112 of the substrate 110. The substrate 110 can have an A-side 114 and a B-side 116. The ETC coating 120 can be applied to at least the A-side 114, though in some embodiments, the ETC coating 120 can be applied to both the A-side 114 and the B-side 116. The article 100 can further include an optical coating 130 disposed between the surface 112 of the substrate 110 and the ETC coating 120. As previously discussed, the methods disclosed herein include providing the substrate 110 having the at least one surface 110. The substrate 110 can be a glass substrate or a glass ceramic substrate. An example of a glass substrate suitable for the present disclosure can include CORNING® GORILLA® glass manufactured and marketed by Corning Incorporated. Other glass or glass ceramic substrates are contemplated.

The substrate 110 can be a bare glass or glass ceramic substrate, a textured glass, a textured glass ceramic, or a glass or glass ceramic substrate having an optical coating (AR) applied to the at least one surface (e.g., the A-side surface). In embodiments, the substrate 110 can be a bare glass substrate, bare glass ceramic substrate, textured glass substrate, or textured glass ceramic substrate, and the ETC coating 120 can be applied directly to the surface 112 of the substrate 110. In embodiments, the substrate 110 can have one or more optical coatings 130 applied to the surface 112 of the substrate 110, and the ETC coating 120 can be applied to an outer surface 132 of the optical coating 130.

The substrate 110 can be a plurality of individual articles or a sheet of the substrate prior to separating the sheet into a plurality of individual articles. In embodiments, the substrate 110 can be cut or otherwise separated into a plurality of individual articles upstream of inkjet printing the ETC coating 120 onto the substrate 110. In embodiments, the substrate 110 can be a large sheet from which a plurality of individual coated articles can be separated after inkjet printing the ETC coating 120 onto the surface 112 of the substrate 110. In embodiments, the substrate 110 can be a continuous or semi-continuous ribbon of glass or glass ceramic that can be conveyed or indexed through the inkjet printing process and then separated into individual coated articles after curing the ETC coating 120.

Prior to inkjet printing the ETC coating 120 onto the substrate 110, the method can include preparing the substrate 110, such as but limited to ion-exchanging the substrate 110, applying one or more optical coatings 130 onto the surface 112 of the substrate 110, decorating the B-side of the substrate 110, cutting the substrate 110 into a plurality of individual articles, or combinations of these. In embodiments, the methods disclosed herein can include ion-exchanging the substrate 110 before inkjet printing the ETC coating composition onto the at least one surface 112 of the substrate 110. Ion-exchanging can improve the strength and durability of the glass or glass ceramic of the substrate 110. Ion-exchanging is generally conducted prior to coating the surface 112 of the substrate 110 with the ETC coating 120, optical coating 130, or both.

In embodiments, the methods disclosed herein can include applying or depositing one or more optical coatings 130 onto the surface 112 of the substrate 110, and then inkjet printing the ETC coating 120 onto the outer surface 132 of the optical coatings 130. The optical coatings 130 can include one or more anti-reflective (AR) coatings, anti-glare coatings, protective capping layers, or combinations of these. Any other optical coatings modifying the optical properties of the substrate 110 or protecting the substrate 110 from degradation can be applied. The optical coatings 130 can be applied through any suitable process, such as but not limited to a PVD process. In embodiments, the method does not include depositing an optical coating 130 onto the surface 112 of the substrate 110 prior to inkjet printing the ETC coating 120.

In embodiments, the method disclosed herein can include subjecting the surface 112 of the substrate 110 to an anti-glare surface treatment, and then inkjet printing the ETC coating 120 onto the surface 112 of the substrate 110. The anti-glare surface treatment may include treating the surface 112 of the substrate 110 to produce a texture on the surface 112 of the substrate 110. The anti-glare surface treatment can include any known or future developed process capable of imparting a non-smooth texture to the surface 112 of substrate 110. In embodiments, the method does not include subjecting the surface 112 of the substrate 110 to an anti-glare surface treatment prior to inkjet printing the ETC coating 120.

As previously discussed, the methods disclosed herein can include preparing an ETC coating composition, which is effectively the ink for the inkjet printing process. There are challenges to inkjet printing certain existing ETC materials. For example, certain materials commonly employed in such coatings, such as fluorinated ETC materials (e.g., silane functionalized PFPE), have low surface tension, which is the desired property for repelling smudges and/or making cleaning easier. However, the low surface tension of these materials can lead to issues during ink-jetting, such as but not limited to surface wetting or poor drop formation. ETC formulations currently used in spraying processes are not suited for inkjet printing due to the low viscosity. The viscosity of the ETC solution is around 0.6 cP for spray coating operations, which is too low for inkjet printing applications.

The ETC coating compositions disclosed herein comprise at least one polymer and a solvent. The ETC coating compositions disclosed herein have greater viscosities than certain existing spray coating compositions, which renders the ETC coating compositions disclosed herein suitable for inkjet applications. In embodiments, the ETC coating compositions described herein may comprise viscosities ranging from 2 centipoise (cP) to 30 cP, where the viscosity is determined according to the test methods disclosed herein. The greater viscosity can be achieved by selecting a solvent having a viscosity of from 2 cP to 30 cP, by including a viscosity modifier in the ETC coating composition, or both.

The ETC coating composition comprises at least one polymer. The polymer can be a fluorinated material with one or more silane moieties, where the fluorinated material provides the material repellent properties and the silane moieties can facilitate bonding the ETC coating to the substrate or to the optical coating applied to the substrate. In embodiments, the at least one polymer of the ETC coating composition can comprise a silane functionalized perfluoropolyether, such as but not limited to perfluoropolyether silane (Si-PFPE). Other fluorinated polymers with silane functional groups are contemplated.

The ETC coating composition can include an amount of the polymer sufficient to form a suitable ETC coating after inkjet printing, but not so much that the viscosity of the ETC coating composition becomes unsuitable for inkjet printing. In embodiments, the ETC coating composition can include greater than or equal to 0.08 volume percent (vol. %), greater than or equal to 0.12 vol. %, greater than or equal to 0.16 vol. %, or greater than or equal to 0.20 vol. % polymer based on the total volume of the ETC coating composition. If the concentration of the polymer is less than 0.08 vol. %, the amount of polymer may not be sufficient to provide the repellant properties to the surface of the substrate following inkjet printing. The ETC coating composition can comprise less than or equal to 20 vol. %, less than or equal to 15 vol. %, or less than or equal to 10 vol. % polymer based on the total volume of the ETC coating composition. When the concentration of the polymer in the ETC coating composition is greater than about 20 vol. %, the ETC coating composition may not have a viscosity suitable for inkjet printing the ETC coating composition. The ETC coating composition can comprise from 0.08 vol. % to 20 vol. %, from 0.08 vol. % to 15 vol. %, from 0.08 vol. % to 10 vol. %, from 0.08 vol. % to 5 vol. %, from 0.08 vol. % to 1 vol. %, from 0.08 vol. % to 0.5 vol. %, from 0.12 vol. % to 20 vol. %, from 0.12 vol. % to 15 vol. %, from 0.12 vol. % to 10 vol. %, from 0.12 vol. % to 5 vol. %, from 0.12 vol. % to 1 vol. %, or from 0.12 vol. % to 0.5 vol. % of the polymer based on the total volume of the ETC coating composition. In embodiments, the ETC coating composition can include 0.12 vol. % of the polymer based on the total volume of the ETC coating composition. Volume percent refers to the volume of a particular constituent over the total volume of the composition at standard temperature and pressure. It is noted that the polymers are typically sold as a solution comprising at least some solvent already incorporated into the commercially available product. The volume percentages above are based on the actual volume of the polymer rather than the volume of the commercially available solution comprising polymer and solvent.

The balance of the ETC coating composition can include the solvent. The solvent can be any one solvent or combination of solvents having a viscosity of from 1.2 cP to 30 cP and capable of forming a homogeneous solution of the polymer. In embodiments, the solvent can comprise one or more of a fluoroether solvent, a hydrofluoroether solvent, a perfluorocarbon solvent, a glycol, a glycol ether, a glycol ester, an alcohol, a hydrocarbon solvent, or combinations of these. In embodiments, the solvent can comprise a perfluorocarbon solvent. In embodiments, the solvent can comprise a fluoroether solvent. Some examples of suitable commercially available solvents from 3M are provided in Table 1.

TABLE 1

| Solvent Name | Solvent Type | Viscosity (cP) |
|---|---|---|
| 3M ™ HFE7200 | Hydrofluoroether | 0.6 |
| 3M ™ HFE 7300 | Hydrofluoroether | 1.2 |
| 3M ™ HFE7500 | Hydrofluoroether | 1.2 |
| 3M ™ HFE 7700 | Hydrofluoroether | 4.5 |
| 3M ™ FLUORINERT ™ FC-770 | Perfluorocarbon | 1.4 |
| 3M ™ FLUORINERT ™ FC-40 | Perfluorocarbon | 4.1 |
| 3M ™ FLUORINERT ™ FC-43 | Perfluorocarbon | 4.7 |
| 3M ™ FLUORINERT ™ FC-70 | Perfluorocarbon | 18 |
| 3M ™ FLUORINERT ™ FC-5312 | Perfluorocarbon | 24 |
| Solvay Galden D02TS | Perfluoropolyethe | 3 |
| Solvay Galden HT170 | Perfluoropolyethe | 3.2 |
| Solvay Galden D03 | Perfluoropolyethe | 4.3 |
| Solvay Galden HT200 | Perfluoropolyethe | 4.3 |
| Solvay Galden LS200 | Perfluoropolyethe | 4.5 |
| Solvay Galden LS215 | Perfluoropolyethe | 6.8 |
| Solvay Galden LS230 | Perfluoropolyethe | 8 |
| Solvay Galden HT230 | Perfluoropolyethe | 8 |
| Solvay Galden HS240 | Perfluoropolyethe | 9.6 |
| Solvay Galden HS260 | Perfluoropolyethe | 12.8 |

In embodiments, the ETC coating compositions can include a plurality of different solvents, where each of the plurality of different solvents has a different viscosity from the other solvents. The ETC coating composition having a plurality of different solvents can have a viscosity of from 2 cP to 30 cP. The viscosity of the ETC coating composition can be fine-tuned by changing the types, relative amounts, or both of the different solvents in the ETC coating composition. The ETC coating compositions can be fine-tuned to have a viscosity suitable for a particular make or model of inkjet printhead.

Referring now to FIG. 3, the viscosity (y-axis) as a function of the relative concentrations of a mixture of two solvents (x-axis) is graphically depicted. In FIG. 3, reference number 302 refers to a lower viscosity limit for one type of inkjet printhead, and reference number 304 refers to a lower viscosity limit for a different type of inkjet printhead, which are provided to give an idea of the operating viscosity range of typical inkjet systems. Reference number 306 refers to the viscosity of the mixture of solvents. The mixture of solvents comprises a mixture of 3M™ FLUORINERT™ FC-40 having a viscosity of 4.1 cP and 3M™ FLUORINERT™ FC-70 having a viscosity of 18 cP. The concentration of 3M™ FLUORINERT™ FC-70 is on the bottom x-axis, and the concentration of 3M™ FLUORINERT™ FC-40 is on the top x-axis. As shown in FIG. 3, the viscosity of the ETC coating composition can be fine-tuned by using two or more different solvents and changing the ratio of those two solvents in the ETC coating composition.

The ETC coating composition can include the amount of the polymer, and the balance of the ETC coating composition can be the solvent. In embodiments, the ETC coating composition can include from 50 vol. % to 99.92 vol. % solvents based on the total volume of the ETC coating composition. The ETC coating composition can include from 50 vol. % to 99.88 vol. %, from 50 vol. % to 99.5 vol. %, from 50 vol. % to 99 vol. %, from 50 vol. % to 95 vol. %, from 50 vol. % to 90 vol. %, from 80 vol. % to 99.92 vol. %, from 80 vol. % to 99.88 vol. %, from 80 vol. % to 99.5 vol. %, from 80 vol. % to 99 vol. %, from 80 vol. % to 95 vol. %, from 80 vol. % to 90 vol. %, from 85 vol. % to 99.92 vol. %, from 85 vol. % to 99.88 vol. %, from 85 vol. % to 99.5 vol. %, from 85 vol. % to 99 vol. %, from 85 vol. % to 95 vol. %, from 85 vol. % to 90 vol. %, from 90 vol. % to 99.92 vol. %, from 90 vol. % to 99.88 vol. %, from 90 vol. % to 99.5 vol. %, from 90 vol. % to 95 vol. %, from 95 vol. % to 99.92 vol. %, from 95 vol. % to 99.88 vol. %, from 95 vol. % to 99.5 vol. %, from 95 vol. % to 99 vol. %, from 99 vol. % to 99.92 vol. %, from 99 vol. % to 99.88 vol. %, from 99.5 vol. % to 99.92 vol. %, or from 99.5 vol. % to 99.88 vol. % of the solvent or solvents based on the total volume of the ETC coating composition.

Alternatively or additionally, in embodiments, the ETC coating composition can include a viscosity modifier. The viscosity modifier may enable the ETC coating composition to include solvents having viscosity less than 2 cP, such as less than 1.2 cP. In embodiments, the viscosity modifier can be a non-functionalized PFPE oil, meaning oils consisting of a perfluoropolyether without a silane functional group. Non-functionalized PFPE oils can include FOMBLIN® PFPE lubricants available from Solvay, which come in a range of molecular weights and viscosities. In embodiments, the viscosity modifier can comprise a FOMBLIN® PFPE lubricant. In embodiments, the non-functionalized PFPE can have an average molecular weight of from 1500 g/mol to 22000 g/mol. In embodiments, the ETC coating composition can include the same solvent used in the spray coating application and a viscosity modifier to adjust the viscosity into a viscosity range suitable for the inkjet printing.

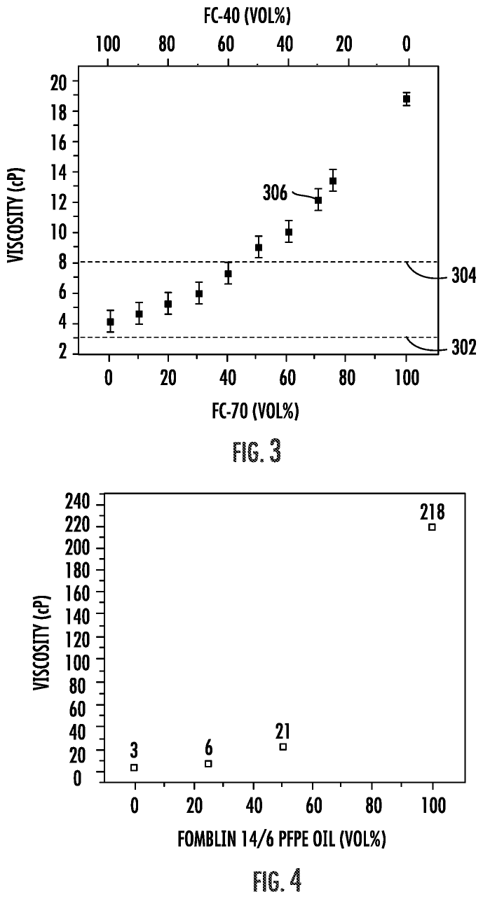

The ETC coating composition can comprise an amount of the viscosity modifier sufficient to adjust the viscosity into the range suitable for inkjet printing. However, viscosity modifiers, such as FOMBLIN® PFPE lubricants and other non-functionalized PFPE materials, are non-volatile and generally remain on the coated article after curing the ETC coating. In some instances, the presence of the non-functionalized PFPE can be beneficial in that the excess unbound PFPE materials can help to pass the required abrasion testing. However, if the amount of non-functionalized PFPE is too high, it may impede the ability of the polymer to bind to the glass surface, or may cause undesirable attributes such as haze or an oily feeling when touched. Referring now to FIG. 4, the viscosity (y-axis) as a function of volume percent of FOMBLIN® PFPE lubricant (x-axis) is graphically depicted for various mixtures of a fluorinated solvent having viscosity 3 cP and FOMBLIN® PFPE lubricant Y 14/6. As shown in FIG. 4, the viscosity can be increased to values suitable for DOD inkjet printing by using less than or equal to 50 vol. % of the FOMBLIN® PFPE lubricant.

In embodiments, the ETC coating composition can include from 1 vol. % to 50 vol. % viscosity modifier based on the total volume of the ETC coating composition. In embodiments, the ETC coating composition can comprise from 1 vol. % to 40 vol. %, from 1 vol. % to 35 vol. %, from 1 vol. % to 30 vol. %, from 1 vol. % to 25 vol. %, from 10 vol. % to 50 vol. %, from 10 vol. % to 40 vol. %, from 10 vol. % to 35 vol. %, from 10 vol. % to 30 vol. %, or from 10 vol. % to 20 vol. % of the viscosity modifier based on the total volume of the ETC coating composition.

The ETC coating compositions can be prepared by combining the polymer, the solvent, and, optionally, the viscosity modifier and mixing the ETC coating composition to produce a homogeneous mixture. The ETC coating composition can have a viscosity of from 2 cP to 30 cP, from 2 cP to 25 cP, from 2 cP to 18 cP, from 4 cP to 30 cP, from 4 cP to 25 cP, or from 4 cP to 18 cP. The viscosity of the ETC coating composition can be adjusted based on the type and model of the inkjet printhead used. As previously discussed, the viscosity of the ETC coating composition can be modified by changing the composition of the solvent, the concentration of an optional viscosity modifier, or both. In embodiments, the ETC coating composition can have a surface tension of from 16 mN/cm to 18 mN/cm, according to the surface tension measurement method provided herein.

Following preparation of the ETC coating composition, the methods disclosed herein include inkjet printing the ETC coating composition onto the surface 112 of the substrate 110 or the outer surface 132 of the optical coating 130 with an inkjet printing system. The ETC coating composition can be inkjet printed onto the substrate 110 with one or more inkjet printing systems. Referring to FIG. 5, the inkjet printing system 200 can include one or more inkjet printheads 210, a positioning system 220 operable to position the inkjet printhead 210 relative to the substrate 110, and an inkjet control system 230 in electronic communication with the inkjet printhead 210 and the positioning system 220. The positioning system 220 can be any type of positioner operable to position the inkjet printhead 210 relative to the surface 112 of the substrate 110. A typical positioning system 220 may include one or more rails and one or more servo motors that, together, enable positioning the inkjet printhead 210 in an X-Y plane relative to surface 112 of the substrate 110. Other types of positioners are contemplated. The positioning system 220 can be communicatively coupled to the control system 230 for control of the positioning system 220. In embodiments, the inkjet printing system 200 does not have a positioning system 220, such as when the inkjet printhead has a number of nozzles sufficient to cover the entire width of the substrate, and therefore, does not require a positioner to move the printhead laterally across the width of the substrate. In embodiments, the inkjet printing system 200 can have multiple printheads to cover the entire surface 112 of the substrate 110, to ensure sufficient print resolutions, or both.

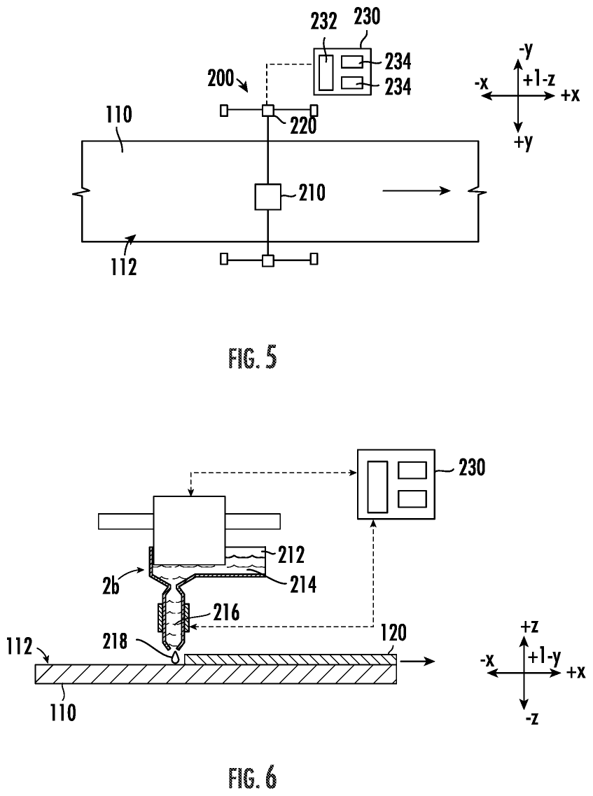

The inkjet printhead 210 may be any type of inkjet printhead capable of depositing uniform droplets of the ETC coating composition onto the surface 112 of the substrate 110. Types of inkjet printheads 220 can include piezoelectric inkjet printheads, thermal bubble printheads, or other suitable inkjet printheads. Referring to FIG. 6, a side cross-sectional view of one embodiment of an inkjet printing system 200 is schematically depicted. The inkjet printhead 210 can include a reservoir 212 for containing a volume of the ETC coating composition 214. The inkjet printhead 210 can further include at least one nozzle 216, which can be operable to receive the ETC coating composition 214 from the reservoir 212 and dispense individual droplets 218 of the ETC coating composition 214 onto the surface 112 of the substrate 110. In embodiments, the inkjet printhead 210 can include a plurality of nozzles 216. The number of nozzles is not particularly limited. Examples of inkjet printheads 210 suitable for the methods disclosed herein include but are not limited to the inkjet printheads provided in Table 2, which also includes the viscosity ranges for the inkjet printheads.

TABLE 2

| Manufacturer | Inkjet Printhead model | Viscosity Range (cP) |
|---|---|---|
| Konica Minolta | KM 1024i | 8-15 |
| Xaar | 1003 GS6U | 9-30 |
| Epson | DX5 | 3-7 |
| FUJIFILM Dimatix | SAMBA ® G3L | 2-7 |

The inkjet printhead 210 can be communicatively coupled to the control system 230 for control of the inkjet printhead 210. The inkjet control system 230 can be operable to control the timing and drop size of the individual droplets 218 by controlling operation of the inkjet printhead 210. The control system 230 can include one or more waveform algorithms for controlling jetting of the ETC coating composition with the inkjet printhead 210. Generally, the inkjet printhead 210 and control system 230 can be included together in the inkjet printing system 200.

The inkjet printing system 200 can be capable of producing individual droplets 218 of the ETC coating composition having substantially more consistent droplet trajectory, droplet velocity, and droplet size compared to spray coating. The control of the trajectory and velocity of the droplets of ETC coating composition provided by inkjet printing process can reduce or prevent the chances or overspray and can enable more precise placement of the individual droplets compared to spray coating. More precise control of placement of the individual drops of the ETC coating composition can enable patterning of the ETC coating on the surface of the substrate to create designs and/or thicker or thinner regions of the ETC coating. Control of the trajectory and velocity of the individual droplets can also enable alternative orientations of the inkjet printing process, such as arranging the substrate vertically (e.g., parallel to the +/−Z direction of the coordinate axis in FIGS. 5 and 6) and projecting the individual droplets horizontally (e.g., in the X-Y plane of the coordinate axis in FIGS. 5 and 6) onto the vertical surface of the substrate.

Inkjet printing the ETC coating composition onto the surface 112 of the substrate 110 can include successively depositing a plurality of individual droplets onto the at least one surface of the substrate with an average droplet size of each of the plurality of individual droplets being sufficient to produce an even ETC coating on the surface 112 of the substrate 110 following curing. The droplet size of the individual droplets of the ETC composition can be characterized by either the droplet volume, the droplet diameter, or both. In embodiments, the individual droplets of the ETC coating composition can have an average droplet volume of from 2 picoliters (pL) to 100 pL, such as from 2 pL to 60 pL, from 2 pL to 50 pL, from 2 pL to 40 pL, from 2 pL to 30 pL, or from 2 pL to 20 pL. In embodiments, the individual droplets of the ETC coating composition can have an average droplet diameter of from 1 micrometer (μm) to 200 μm.

Modifying the droplet size (e.g., droplet volume or droplet diameter) of the individual droplets of the ETC coating composition can change the thickness of the ETC coating produced after curing the plurality of droplets of the ETC coating. For example, increasing the droplet size at the same print resolution increases the amount of the ETC coating composition, which can increase the thickness of the ETC coating produced through inkjet printing the ETC coating composition and curing. Likewise, decreasing the droplet size of the individual droplets can reduce the thickness of the ETC coating by reducing the amount of material laid down on the substrate. For a fixed resolution, reducing the average droplet size below a certain threshold droplet size, at which coalescence of the droplets occurs, can cause isolated droplets of the ETC coating composition to be deposited on the surface of the substrate, which can be useful to change the coefficient of friction (CoF) of the surface in some applications. Changing the CoF of the surface in some regions can be useful for creating a texture to aid a user in finding the location of a particular user interface feature, such as a button, among other uses. Changing the droplet size of the individual droplets can also change the print resolution that is needed to achieve full coverage of the surface of the substrate.

The droplet size (e.g., droplet volume or droplet diameter) of the ETC coating composition produced by the inkjet printing system can be consistent such that the droplet size has a low degree of variation from the average droplet size. In particular, each of the plurality of individual droplets of the ETC coating composition jetted can have a droplet volume that is different from the average droplet volume by less than 5%, less than 4%, or even less than 3% of the average droplet volume. In embodiments, greater than at least 99% of the individual droplets jetted can have a droplet volume that is within 5%, within 4%, or even within 3% of the average droplet volume.

The methods disclosed herein can include inkjet printing the ETC coating composition at a resolution sufficient to produce an even ETC coating on the surface of the substrate. An even ETC coating is an ETC coating that provides full coverage of the surface of the substrate in the regions where the ETC coating is applied. As used herein, the resolution refers to the number of pixels per unit area printed by the inkjet printing system. In embodiments, the methods can include inkjet printing the ETC coating composition on the surface of the substrate at a resolution of from 150 dots per inch (dpi) to 2400 dpi. In embodiments, the methods can include inkjet printing the ETC coating composition at a resolution of from 150 dpi to 2100 dpi, from 150 dpi to 1800 dpi, from 150 dpi to 1500 dpi, from 300 dpi to 2400 dpi, from 300 dpi to 2100 dpi, from 300 dpi to 1800 dpi, from 300 dpi to 1500 dpi, from 500 dpi to 2400 dpi, from 500 dpi to 2100 dpi, from 500 dpi to 1800 dpi, from 500 dpi to 1500 dpi, from 1200 dpi to 2400 dpi, from 1200 dpi to 2100 dpi, from 1200 dpi to 1800 dpi from 1200 dpi to 1500 dpi, from 1500 dpi to 2400 dpi, or from 1500 dpi to 2100 dpi.

In embodiments, the thickness of the ETC coating can be modified by changing the resolution of the inkjet printing system. For instance, increasing the resolution increases the number of pixels of the ETC coating composition per unit area. At constant average droplet size (e.g., droplet volume or droplet diameter), increasing the number of pixels per unit area increases the total volume of ETC coating composition inkjet printed onto the substrate per unit area, which increases the thickness of the ETC coating produced after curing. Likewise, the thickness of the ETC coating can be reduced by reducing the inkjet printing resolution to reduce the amount of the ETC coating composition applied to the surface of the substrate per unit area, at constant droplet size. For a fixed average droplet size, reducing the print resolution below a certain threshold resolution, which is the resolution at which coalescence of the droplets occurs, can cause isolated droplets of the ETC coating composition to be deposited on the surface of the substrate without coalescence. This can result in a pattern of individual droplets of the ETC coating separated by regions of uncoated surface of the substrate. Incomplete coverage of the surface of the substrate with the ETC coating can be useful to change the coefficient of friction (CoF) of the surface of the substrate, in some applications.

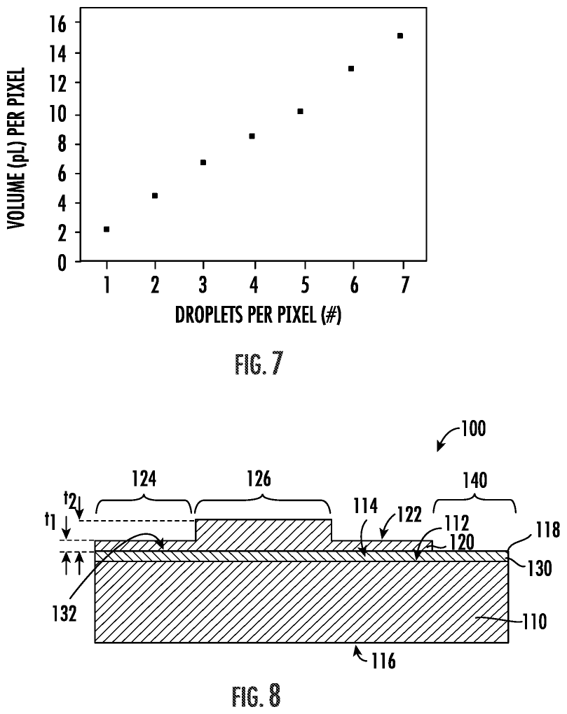

In embodiments, the inkjet printing system can be configured to print a plurality of droplets for each pixel of resolution. In particular, the inkjet printing system can comprise a waveform configured to produce multiple pulses, which can be selectively enabled to produce different drop sizes. In other words, at each pixel position of the inkjet printhead, the control system can be configured via the waveform to cause each of the nozzles of the inkjet printhead to jet two or more droplets of the ETC coating composition in rapid succession at each pixel location before moving on to the next set of pixels. Inkjet printing multiple droplets per pixel can be referred to as printing different grey levels. Inkjet printing a plurality of individual droplets of the ETC coating composition at each pixel can increase the quantity of the ETC coating composition applied to the substrate at each pixel through coalescence of the droplets before reaching the surface of the substrate or as the droplets combine on the surface of the substrate. In embodiments, the multiple droplets of the ETC coating composition expressed by the inkjet printhead can coalesce in flight between the printhead and the substrate to form a single droplet having a droplet volume of the ETC coating composition greater than droplet volume of each individual droplet. Referring now to FIG. 7, the volume of the ETC coating composition per pixel (y-axis) as a function of the number of individual droplets jetted per pixel (x-axis) is graphically depicted. As shown in FIG. 7, the volume of ETC coating composition per pixel increases linearly with the number of individual droplets per pixel. In embodiments, inkjet printing the ETC coating composition onto the surface of the substrate can include inkjet printing from 1 individual droplet to 7 individual droplets of the ETC coating composition at each pixel position, such as 1, 2, 3, 4, 5, 6, or 7 individual droplets of the ETC coating composition at each pixel position. The number of droplets per pixel can be referred to herein as the grey level, where the grey level is equal to the number of droplets per pixel. The grey level can be changed by modifying the waveform in the algorithm for controlling the inkjet printhead, such as by changing a frequency of the waveform.

In embodiments, the ETC coating composition can be inkjet-printed at a frequency of from 500 hertz (Hz) to 15,000 Hz, such as from 500 Hz to 10,000 Hz, from 500 Hz to 5000 Hz, from 500 Hz to 1000 Hz, from 1000 Hz to 15,000 Hz, from 1000 Hz to 10,000 Hz, or from 1000 Hz to 5000 Hz. Increasing the frequency of printing can enable greater throughput of the substrate through the inkjet printing process. In embodiments, increasing the print frequency can also enable multi-pass printing, where the printhead moves over the substrate multiple times at each print location.

Increasing or decreasing the number of individual droplets of the ETC coating composition at each pixel position, at constant resolution and drop size, can increase or decrease, respectively, the thickness of the ETC coating resulting from the inkjet printing and curing. For instance, increasing the number of individual droplets per pixel can increase the thickness of the ETC coating. Likewise, decreasing the number of individual droplets printed per pixel can decrease the thickness of the ETC coating. In some instances, such as when inkjet printing at low resolution (e.g., <1000 dpi), printing with a small average droplet volume (e.g., <5 pL), or both, reducing the number of droplets printed per pixel below a threshold number of droplets can result in no coalescence of the ETC coating composition between pixels, which leads to a pattern of individual pixels of the ETC coating composition separated by uncoated surface instead of an even ETC coating across the surface. As previously discussed, printing individual pixels separated by uncoated surface can be useful for modifying the CoF of the surface.

In embodiments, the inkjet printing system can include a plurality of inkjet printing stations in succession, each inkjet printing station having an independent positioning system and inkjet printhead. Subsequent inkjet printing stations downstream of the primary printing station can increase the thickness of the ETC coating on the surface of the substrate. Increasing the number of inkjet printing stations in succession can increase the thickness of the ETC coating, and decreasing the number of inkjet printing stations in succession can decrease the thickness of the ETC coating. In embodiments, the inkjet printing system can include a plurality of printhead bars arranged in succession, where each of the printhead bars are communicatively connected to the control system and controlled by the same control system. In this configuration, the single control system can control all of the plurality of printhead bars as a single system. The term “printhead bar” refers to the combination of the printhead and positioner or to a printhead that extends laterally all the way across the width of the substrate (no positioner needed).

The inkjet printing system can enable the thickness of the ETC coating to be different in different regions of the surface of the substrate. For instance, high touch frequency areas, such as areas for touch screens or buttons, can have a greater thickness of the ETC coating applied compared to other areas, such as screen borders or display only screens. The methods disclosed herein can include inkjet printing different thicknesses of the ETC coating in different regions of the surface of the substrate. In embodiments, the methods can include inkjet printing the ETC coating composition in a first region of the at least one surface of the substrate to produce the ETC coating in the first region having a first thickness, and inkjet printing the ETC coating composition in a second region of the at least one surface of the substrate to produce the ETC coating in the second region having a second thickness, where the second thickness is different from the first thickness. As previously discussed, the thickness can be varied by changing the drop size of the individual droplets of the ETC coating composition, changing the resolution (dpi) of the pixels for inkjet printing the ETC coating composition, modifying the number of individual droplets of ETC coating composition dispensed per pixel, inkjet printing multiple layers of the ETC coating composition with one or more subsequent inkjet printing stations, or combinations of these.

In embodiments, inkjet printing different thicknesses of the ETC coating in different regions of the surface of the substrate can include inkjet printing the ETC coating composition at a first droplet size in the first region of the surface of substrate, and inkjet printing the ETC coating composition at a second droplet size different from the first droplet size in the second region of the surface of the substrate. In embodiments, inkjet printing different thicknesses of the ETC coating in different regions of the surface of the substrate can include inkjet printing the ETC coating composition at a first resolution (dpi) in the first region of the surface of substrate, and inkjet printing the ETC coating composition at a second resolution (dpi) different from the first resolution in the second region of the surface of the substrate. In embodiments, inkjet printing different thicknesses of the ETC coating in different regions of the surface of the substrate can include inkjet printing the ETC coating composition at a first number of individual droplets per pixel in the first region of the surface of substrate, and inkjet printing the ETC coating composition at a second number of individual droplets per pixel in the second region of the surface of the substrate, where the second number of individual droplets is different from the first number of individual droplets.

In embodiments, inkjet printing different thicknesses of the ETC coating in different regions of the surface of the substrate can include printing a first layer of the ETC coating composition onto an area of the surface of the substrate using a first inkjet printing station, and inkjet printing a subsequent layer of the ETC coating composition onto the first layer in one or more regions within the area of the surface of the substrate, where the first regions comprise only the first layer and the second regions comprise the first layer and second layer and have a thickness of the ETC coating that is greater than the thickness of the ETC coating in the first regions. Additional regions of even greater thickness can be formed by inkjet printing one or more subsequent layers of the ETC coating composition in different regions using additional downstream inkjet printing stations or downstream printhead bars, as previously discussed herein.

In embodiments, the inkjet printing the ETC coating composition can include printing one or more patterns at a patterned region of the substrate, where the patterns can provide tactile feel to one or more features of the coated article.

In embodiments, at least some portions of the surface of the substrate can be free of the ETC coating composition. In embodiments, inkjet printing the ETC coating composition onto the surfaces of the substrate can include not inkjet printing the ETC coating around an outer border of the surface of the substrate. In embodiments, inkjet printing the ETC coating composition on a first surface of the substrate (e.g., the A-side of the substrate) does not result in deposition of the ETC coating composition on a second surface of the substrate (e.g., the B-side of the substrate) or on any surfaces of equipment around the substrate.

Following inkjet printing of the ETC coating composition onto the surface of the substrate, the methods disclosed herein can include curing the ETC coating composition to produce the ETC coating bonded to the surface of the substrate. The curing step results in condensation of the silane portion of the polymer (e.g., silane functionalized PFPE) with the glass or glass ceramic at the surface of the substrate. Curing can include maintaining the temperature of the ETC coating composition and substrate at a temperature of from ambient temperature to 200° C., such as from 25° C. to 200° C. or from 25° C. to 170° C., for a cure time of from 24 hours at ambient temperature to about 30 minutes at 170° C. The cure time is inversely proportional to the cure temperature. Thus, as the cure temperature is increased, the cure time can be decreased. In embodiments, curing can include maintaining the ETC coating composition and substrate at ambient temperature for a cure time of about 24 hours, or at a temperature of from about 150° C. to about 200° C. for a cure time of about 30 minutes.

Following curing, the methods can include wiping the outer surface of the ETC coating applied to the substrate. Wiping can include passing a cloth over the outer surface of the ETC coating, which can remove any uncured ETC coating composition from the outer surface of the ETC coating. The cloth can be dry or wetted with a solvent, such as but not limited to a fluorosolvent, isopropyl alcohol (IPA), water, or other solvent. In embodiments, the method does not include wiping the outer surface of the ETC coating.

Referring again to FIG. 2, the coated articles 100 produced by the methods disclosed herein comprise the substrate 110 having at least one surface 112 and an ETC coating 120 applied to the at least one surface 112 of the substrate 110. The substrate 110 can be any of the substrates previously described herein. In embodiments, the substrate 110 can be glass or glass ceramic. In embodiments, the substrate 110 can be an ion-exchanged glass or glass ceramic. In embodiments, the substrate 110 can comprise the optical coating 130 bonded to the surface 112 of the substrate 110, and the ETC coating 120 can be applied to the outer surface 132 of the optical coating 130.

The ETC coating 120 can include any of the polymers previously discussed herein. In embodiments, the ETC coating 120 can be a silane-functionalized PFPE coating bonded to the surface 112 of the substrate 110 or the outer surface 132 of the optical coating 130 by the silane linkage between the PFPE polymer and the substrate 110 or optical coating 130. The ETC coating 120 can have a thickness of from 2 nm to 10 nm, or from 2 nm to 5 nm. The inkjet printing process disclosed herein can produce an ETC coating 120 having a consistent thickness of the ETC coating 120. For regions of the ETC coating having the same average thickness (e.g., either a first region with first thickness or a second region of second thickness, but not a combination of both), the thickness of the ETC coating 120 produced through the inkjet printing process at each point in the region can be less than or equal to about 3%, less than or equal to 2%, less than or equal to 1%, or even less than or equal to about 0.5% of the average thickness of the ETC coating 120.

The cured ETC coating 120 provides repellent properties that can reduce or prevent deposition of dirt, proteins, or oils onto the surface of the coated article 110. The repellent properties of the ETC coating 120 can be characterized by determining a static water contact angle, according to the methods disclosed herein. After curing and optional wiping, but without further abrading of the surface, the ETC coating 120 can have an average static water contact angle of greater than or equal to 110 degrees, or even greater than or equal to 115 degrees. As used herein, the average static water contact angle is computed based on an average of the water contact angle measurements associated with 100 water droplets evenly distributed in a 10×10 array over a 50 mm by 50 mm square section of the cured ETC coating 120, where the water droplets are spaced apart by 5 mm. The inkjet printing process can produce a more consistent ETC coating with respect to static water contact angle compared to spray coating. In regions of the ETC coating 120 having the same thickness and print resolution (e.g., a region that does not include a purposeful change in the thickness of the ETC coating 120 for proving additional durability of the ETC coating in a second region), the ETC coating 120 can have an average static water contact angle of greater than or equal to 110 degrees, or even greater than or equal to 115 degrees, with a tolerance of the static water contact angle of less than or equal to 4 degrees (e.g., at any point within the region, the measured static water contact angle is within 4 degrees of the average static water contact angle), where the static water contact angle is measured on the as applied ETC coating 120 after curing and without cheesecloth abrasion. In embodiments, tolerance of the average static water contact angle can be less than 3 degrees, less than 2 degrees, less than or equal to 1 degree, or even less than or equal to 0.6 degrees.

The ETC coating 120 produced by the inkjet printing process can produce superior durability compared to spray coating, as shown by the ability of the inkjet printed ETC coatings to provide high static water contact angle after being abraded by cheesecloth for 200,000 cycles. The static water contact angle following cheesecloth abrasion of the ETC coating 120 can be determined according to the methods disclosed herein. The ETC coating 120 can exhibit an average static water contact angle of greater than or equal to 100 degrees after abrading the surface of the ETC coating 120 with cheesecloth for 200,000 cycles, according to the methods disclosed herein. A tolerance of the static water contact angle after abrading with cheesecloth for 200,000 cycles can be less than or equal to +/−4 degrees, or even less than or equal to +/−3 degrees, within a region of the ETC coating having the same average thickness (e.g., not including a combined region that includes a purposeful transition between two regions with deliberately different thicknesses). In embodiments, the region of the ETC coating can be an area of about 50 mm by 50 mm for determining the consistency of the static water contact angle. The static water contact angle of the ETC coating after abrading with cheesecloth for 200,000 cycles can be within 10% of the static water contact angle of the ETC coating before abrading with the cheesecloth.

As previously discussed, in embodiments, the coated article 100 can comprise the optical coating 130 bonded to the surface 112 of the substrate 100, and the ETC coating 120 can be bonded to the outer surface 132 of the optical coating 130. The optical coating 130 is not particularly limited and can include any type of anti-reflective coating suitable for the application. In embodiments, the optical coating 130 can include a silica cap layer applied to the surface 112 of the substrate 110. The silica cap layer may facilitate bonding of the silane functionalized PFPE of the ETC coating 120 to the substrate 110. In embodiments, the optical coating 130 can include an AR stack comprising a plurality of coating layers. Examples of AR coatings and AR coating stacks suitable for the coated articles 100 can be found in at least International Application Publication Number WO 2019/169293, published on Sep. 6, 2019, entitled “Anti-Reflective Coatings and Articles and Methods of Forming the Same,” the entire contents of which are incorporated herein by reference. Other AR coatings and AR coating stacks are contemplated.

In embodiments, the coated article 100 can include different regions on the outer surface of the substrate having different thicknesses of the ETC coating. Referring now to FIG. 8, in embodiments, the coated article 100 can comprise the ETC coating 120 having at least one first region 124 with a first thickness t₁ of the ETC coating 120 and at least one second region 126 with a second thickness t₂ of the ETC coating 120. While the at least one first region 124 is depicted to be adjacent to the at least one second region 126, embodiments are also envisioned where the at least one first region 124 and at least one second region 126 are separated from one another by an area on the surface 112 devoid of ETC coating (e.g., by one or more uncoated regions 140, as described herein). As depicted in FIG. 8, the second thickness t₂ of the ETC coating 120 in the second region 126 can be different from the first thickness t₁ of the ETC coating 120 in the first region 124. The difference between the first thickness t₁ and the second thickness t₂ is deliberate and enabled by the inkjet printing process as previously discussed, and the difference here is intended to refer to a difference between t₁ and t₂ that is greater than the tolerance of the thickness. In embodiments, an absolute value of the difference between the second thickness t₂ and the first thickness t₁ can be greater than or equal to 6%, or greater than or equal to 10% of the first thickness t₁.

The first thickness t₁ can be consistent in the first region 124, and the second thickness t₂ can be consistent in the second region. In embodiments, the first thickness t₁ of the ETC coating 120 in the first region 124 can have a tolerance of less than or equal to 5% of the average first thickness t₁ₐᵥₑ, which is the average of the first thickness t₁ taken over the area of the first region 124, where the tolerance in the first thickness t₁ is less than the difference between the second thickness and the first thickness. Likewise, in embodiments, the second thickness t₂ of the ETC coating 120 in the second region 126 can have a tolerance of less than or equal to 5% of the average second thickness t₂ₐᵥₑ, which is the average of the second thickness t₂ taken over the area of the second region 126, where the tolerance in the second thickness t₂ is less than the difference between the second thickness and the first thickness.

As previously discussed, the regions with different thickness of the ETC coating 120 can be formed to provide increased durability of the ETC coating 120 in areas of the coated article 100 expected to have a greater number of touch events or to provide modified tactile feel for buttons or other frequently touched features. Although shown in FIG. 8 as having the first region 124 with first thickness and the second region 126 with a second thickness, it is understood that the ETC coating 120 can have more than two different regions, each of which having a different thickness depending on the need for additional durability or tactile feel. The ETC coating 120 can have 2, 3, 4, 5, 6, or more than 6 different regions, each with a different thickness of the ETC coating 120.

In embodiments, the coated article 100 can have one or more patterned regions (not shown). In the patterned regions, the ETC coating 120 can be printed with a pattern or varying thickness that can provide a different tactile feel to the user compared to the other regions of the ETC coating.

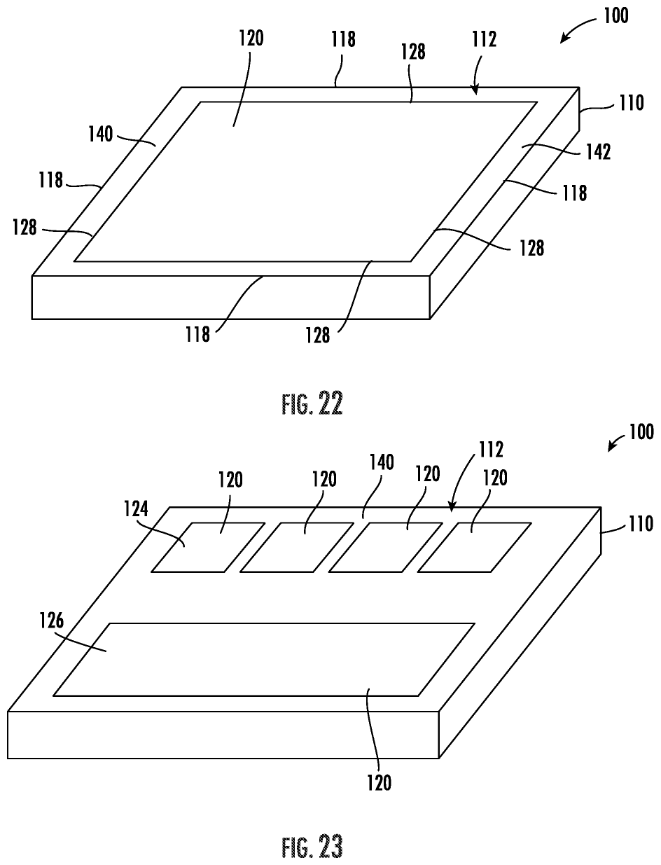

The inkjet printing process disclosed herein can further enable regions of the surface of the substrate to not be inkjet printed thereon, which provides uncoated regions of the A-side surface of the substrate that does not have the ETC coating. Referring again to FIG. 8, in embodiments, the coated article 100 can include one or more uncoated regions 140 that do not have the ETC coating 120 bonded to the surface 112 of the substrate 110 or to the outer surface 132 of the optical coating 130. Referring now to FIG. 22, in embodiments, the coated articles 100 can have an uncoated region 140 disposed proximate to the peripheral edges 118 of the surface 112 of the coated article 100 and extending around the peripheral edges 118 of the surface 112 of the coated article 100. In embodiments, edges 128 of the ETC coating 120 can be spaced apart from the peripheral edges 118 of the substrate to form a band 142 of uncoated region 140 proximate to the peripheral edges 118 of the surface 112 of the substrate 110. Not inkjet printing the ETC coating composition close to the edges of the coated article 100 can reduce or completely prevent contamination of the B-side 116 of the substrate 110 or a carrier plate of the substrate 100 with the ETC coating composition. Additionally, for coated articles 100 comprising screens, such as touch screens, the edges of the coated articles 100 are generally covered by a casing or frame into which the coated article 100 is installed, and therefore, the edges around the periphery of the coated article 100 generally are not expected to experience any touch events.

For embodiments where the coated articles comprises at least one region that does not have the ETC coating, the ETC coating may comprises at least one defined line at the interface between the ETC coating and the uncoated surface of the substrate or uncoated outer surface of the AR coating. The line at the interface is characteristic of inkjet printing and would not be present in spray coated or PVD coated articles without evidence of complex masking.

Referring now to FIG. 23, in embodiments, the coated article 100 can include a plurality of first regions 124 of the ETC coating 120, where the plurality of first regions 124 are spaced apart from each other by uncoated regions 140 of the surface 112 of the substrate 110. The plurality of first regions 124 of the ETC coating 120 separated by the uncoated regions 140 of the surface 112 can form a pattern of the ETC coating 120 on the surface 112 of the substrate 110. The coated article 100 can further include one or a plurality of second regions 126 spaced apart from each other, from the first regions 124, or both, by the uncoated regions 140 to form a more complex pattern.

Referring now to FIG. 24, in embodiments, the pattern of the ETC coating 120 on the surface 112 of the substrate 110 can comprise a plurality of individual dots 144 of the ETC coating 120 printed onto the surface 112. Each of the individual dots 144 is separated from the other individual dots 144 by the uncoated regions 140, thereby forming a pattern of the individual dots 144 across the surface 112 of the substrate 110. The individual dots 144 can be printed by changing the print resolution, average droplet size (e.g., droplet volume or droplet diameter), or both so that the droplets are spaced apart far enough so that they do not coalesce to form a homogeneous coating.

ETC coatings can provide a lubricious touch-feel to the substrate as well as facilitating easy removal of fingerprints and other surface contaminants. The lubricious touch-feel is provided by the fluorinated polymers (e.g., PFPE) used for the ETC coating. However, the lubricious touch-feel may be undesirable for certain applications, such as applications that include the use of a stylus on a touch screen, or other applications. The inkjet printing process disclosed herein can be operated to apply the ETC coating composition in a way where the water contact angle and coefficient of friction (CoF) of the surface of the substrate can be tailored to the particular application with minimal impact to the existing optical properties. The inkjet printing process can be used to produce a coated article with tunable water contact angle and CoF. When inkjet printing the ETC coating composition, the inkjet printing process can be configured to vary the printing resolution from 150 dpi to 2400 dpi, which can produce a coated article comprising a water contact angle range of from 50 degrees to 120 degrees and a CoF of from 0.6 to 0.08. It is further possible to ensure no visible haze from the ETC by controlling the amount of the ETC coating composition deposited. Such ETC coatings have been found to have good abrasion performance when coated on glass or glass plus silica surfaces.

The water contact angle and CoF can be modified by changing the print resolution, the droplet size (e.g., droplet volume or droplet diameter), the grey level (i.e., number of droplets per pixel), or combinations of these. In particular, the print resolution, droplet size, grey level, or combinations of these can be modified to print a plurality of individual droplets of the ETC coating composition onto the surface of the substrate, where the individual droplets are separated from one another by uncoated regions of the substrate 110. Referring now to FIG. 24, after curing, the individual droplets of the ETC coating composition produce individual dots 144 of the ETC coating 120 separated by uncoated regions 140 of the surface 112 of the substrate 110. The individual dots 144 of the ETC coating 120 can have a thickness of less than 10 nanometers. The spacing between each of the plurality of individual dots 144 and the surface area of each of the individual dots 144 of the ETC coating 120 can influence the water contact angle and the CoF of the surface 112 of the coated article 100. The spacing between each of the plurality of individual dots 144 and the surface are of each of the plurality of individual dots 144 can be modified by changing the print resolution, the average droplet size, the grey level, or combinations of these during the inkjet printing process. Thus, the water contact angle and the CoF can be modified by changing the print resolution, the average droplet size, the grey level (i.e., number of droplets per pixel), or combinations of the inkjet printing process.

As previously discussed, the print resolution can be varied between 150 dpi and 2400 dpi. Generally, the print resolution effects the spacing between the individual dots 144 of the ETC coating 120. In particular, reducing the resolution can increase the spacing between the individual dots 144. The average droplet diameter can be varied from 1 μm to 200 μm depending on the type of printhead. The grey level can be varied from 1 to 7. The average droplet size and the grey level can influence the surface area of the individual dots 144 of the ETC coating 120.

Varying the print resolution, the average droplet size, the grey level, or combinations of these can produce a coated article 100 having an average water contact angle of from 50 degrees to 120 degrees. Additionally or alternatively, varying the print resolution, the average droplet size, the grey level, or combinations thereof can produce a coated article 100 having a CoF of from 0.6 to 0.08. The amount of the ETC coating composition applied to the surface of the substrate can be controlled to minimize the effects on the optical properties of the coated article 100. In embodiments, the amount of the ETC coating composition applied to the surface of the substrate can be controlled to reduce or eliminate haze and to provide a surface reflectance of less than or equal to 8%. When inkjet printing a plurality of individual droplets of the ETC coating composition spaced apart by uncoated regions 140, the resulting individual dots 144 of the ETC coating 120 can have a durability as previously discussed herein. In particular, the individual dots 144 of the ETC coating 120 can have an average water contact angle after abrading with cheesecloth for 200,000 cycles that is within 10 degrees of the average water contact angle prior to abrading with cheesecloth.

In embodiments, the coated article 100 can further include one or more other coatings (not shown) applied to the outer surface 122 of the ETC coating 120 on the A-side 114 of the substrate 110.

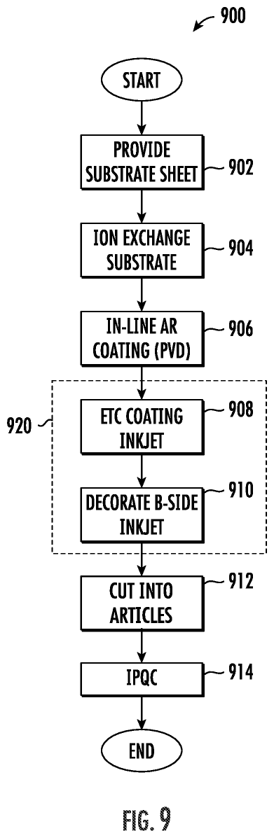

The process for producing the coated articles disclosed herein can include additional processing steps, such as but not limited to cutting the substrate into a plurality of articles, ion-exchanging the substrate, decorating the B-side of the substrate, applying an AR coating through a PVD process, and post processing quality control processes. Ion-exchanging and applying the AR coating were previously discussed herein. Referring to FIG. 9, a flow chart for one embodiment of a manufacturing process 900 for producing coated articles using the inkjet printing process disclosed herein is depicted. The manufacturing process 900 can include providing the substrate (step 902), ion-exchanging the substrate (904), and in-line AR coating through a PVD process (906). Following the in-line AR coating in step 906, the manufacturing process 900 can then include inkjet printing the ETC coating composition and curing to produce the ETC coating in step 908 and decorating the B-side surface of the substrate in step 910. As indicated by reference number 920, inkjet printing the ETC coating 908 and decorating the B-side surface 910 can be completed simultaneously, such as by inkjet printing on both sides of the substrate at the same time. In embodiments, decorating the B-side surface (step 910) can be accomplished after inkjet printing the ETC coating (step 908). The manufacturing process 900 can further include cutting the coated substrate into a plurality of coated articles (step 912) and one or more downstream quality control inspections (step 914). Other post-processing steps can also be conducted.

As previously discussed, the methods can include cutting a sheet of the substrate into a plurality of individual articles, which cutting can be accomplished prior to the inkjet printing or after the inkjet printing. In embodiments, the methods can include cutting the substrate into a plurality of articles comprising at least a portion of the substrate with the ETC coating on the at least one surface of the substrate after curing the ETC coating composition to produce the ETC coating bonded to the at least one surface of the substrate. In embodiments, the substrate can be a continuous ribbon of the substrate, such as a continuous glass ribbon or continuous glass ceramic ribbon, and the method can include, after curing the ETC coating composition to produce the ETC coating, cutting the continuous ribbon of the substrate into individual articles. In embodiments, the substrate can be cut into individual article prior to or upstream of the inkjet printing process. The substrate can be cut into individual articles according to any suitable method know in the art or further to be developed.

The methods can further include decorating the B-side of the substrate. In many applications, the B-side can be decorated with a black band around the outer edge of the article, where the black band can define the display area of a screen such that areas outside the display area of the screen appear black when viewed from the A-side. Other designs for decorating the B-side are contemplated. The B-side can be decorated by printing an ink composition onto the B-side surface of the substrate. The B-side can be decorated by any suitable printing method, such as but not limited to screen printing, inkjet printing, or other printing methods or combinations of printing methods.

In embodiments, the methods can include inkjet printing an ink composition onto the B-side surface of the substrate to decorate the B-side of the substrate. In embodiments, the methods can include inkjet printing a decorative ink on the B-side surface of the substrate after or during inkjet printing the ETC coating composition on the first side of the substrate. In embodiments, methods can include inkjet printing the ETC coating composition on a first side (A-side) of the substrate and inkjet printing the ETC coating composition, a decorative ink, or both on a second side (B-side) of the substrate, where inkjet printing the ETC coating composition, the decorative ink, or both on the second side (B-side) of the substrate can be performed after or during inkjet printing the ETC coating composition on the first side of the substrate.

The inkjet printing process disclosed herein for applying the ETC coating can enable changes to the configuration of the manufacturing process for producing the coated articles, in particular coated articles for automotive display applications.

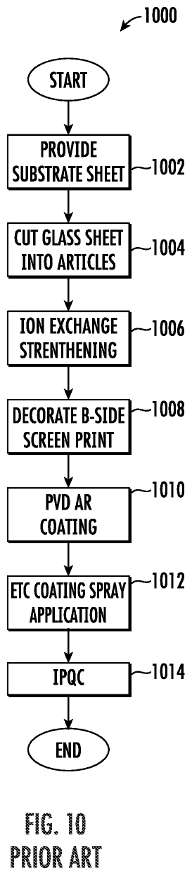

Referring now to FIG. 10, a flow chart for a typical manufacturing process 1000 of the prior art is graphically depicted. As shown in FIG. 10, the prior art process 1000 of making the coated articles include providing the substrate (step 1002) and first cutting the substrate into a plurality of individual substrate (step 1004). Each of the individual substrates are then passed through the rest of the manufacturing process 1000. After cutting (step 1004), the process 1000 can further include ion-exchanging each of the individual pieces of substrate (step 1006), then decorating the B-side surface of the individual substrates (step 1008). Once the B-side surface of the individual substrate pieces is decorated (step 1008), an AR coating can be applied to the A-side surface via a PVD process (step 1010), and then the ETC coating can be applied to the A-side surface through spray coating (step 1012), with quality control inspection (step 1014) downstream of the spray coating (step 1012). As shown in FIG. 10, the spray coating operation in step 1012 is typically the last processing step in the typical manufacturing process 1000 of the prior art.

Application of the ETC coating through inkjet printing according to the methods disclosed herein can open up new opportunities to reorganize and reshape the manufacturing process for producing a variety of different coated articles. Thus, the inkjet printing process disclosed herein for applying the ETC coating can enable greater process flexibility. Referring again to FIG. 9, inkjet printing the ETC coating (step 908) no longer requires the ETC coating to be the last step in the manufacturing process 900. Further, inkjet printing the ETC coating (step 908) can enable the substrate to be processed as a sheet or continuous ribbon of the substrate without first having to cut the substrate into individual pieces first. Thus, inkjet printing the ETC coating can enable the cutting operation can be moved after ion exchange (step 904) the AR coating (step 906), inkjet printing the ETC coating (step 908), and decorating the B-side surface (step 910).

Inkjet printing the ETC coating (step 908) can also enable repositioning of the step of decorating the B-side surface of the substrate (step 910). With inkjet printing the ETC coating, the B-side decorating step 910 can be moved after the PVD process for applying the AR coating (step 906) and after the inkjet printing of the ETC coating (step 908). Moving the B-side decorating step 910 after the PVD process for applying the AR coating (step 906) removes the requirement for the decorative inks to remain stable at the temperatures experienced in the PVD process, such as temperatures greater than 150° C. This opens up the possibility of using different types of decorative inks and different processes for decorating the B-side surface of the substrate.

Further, inkjet printing can enable a vertical orientation of the ETC coating process, which can also enable simultaneous double-sided printing of the substrate. For instance, in embodiments, the methods can include inkjet printing the ETC coating composition onto the A-side surface of the substrate, and at the same time, inkjet printing the B-side surface to decorate the B-side surface of the substrate. In embodiments, the vertical arrangement can enable inkjet printing the ETC coating composition on both the A-side and B-side surfaces of the substrate simultaneously.

The coated articles produced by the methods herein can be used as a screen for one or more user interfaces of an electronic device. The coated articles can be a touch screen for an electronic device. In embodiments, the coated articles produced by the methods disclosed herein can be incorporated into automotive displays or displays for other vehicles. The coated article can be incorporated into a display or touch screen for an instrument panel, an infotainment system, or both for a vehicle, or in any other applications.

Test Methods

Viscosity

The viscosities of the ETC coating composition and/or the solvents included therein are determined through measurement using a DISCOVERY™ HR-2 model rheometer available from TA Instruments. The rheometer is equipped with double gap concentric cylinder cup and rotor. Measurements of the viscosity are taken at 25° C. (unless stated otherwise) and with a shear rate of 100 s⁻¹.

Cheesecloth Abrading

The current durability requirement is determined by cheesecloth abrasion with 200,000 cycles followed by water droplet contact angle measurement. The current durability requirement is a water contact angle remaining above 100 degrees after cheesecloth abrasion through 200,000 cycles. For the cheesecloth abrasion, 5 pieces of cheesecloth (50 mm×50 mm square, 200877, SDL Atlas Textile Innovators) were attached to a round head (20 mm diameter) of an abrader using an O-ring. The abrader was a Model 5750 abrader available from Taber Industries. Weights totaling 410 grams were added to the spindle of the abrader to result in a total applied load of 750 grams. The stroke length was set at 15 mm and the speed was set to 30 cycles per minute. The area to be abraded was marked onto the back of the sample for tracking. Typically, each sample ran for 200,000 cycles, with the cheesecloth material changed every 50,000 cycles. Once the abrasion test was completed, the part was cleaned with a nitrogen gun and characterized using static water contact angles. For easy to clean (ETC) applications, the passing metric for static water contact angle is >100° after 200,000 cycles. The parameters for the cheesecloth abrading process are provided in Table 3.

TABLE 3

| | |
|---|---|
| Abradant material | 5 pieces of cheesecloth (SDL Atlas) |
| Load | 750 grams |
| Abrading head diameter | 20 mm |
| Stroke length | 15 mm |
| Test speed | 30 cycles/minute |
| Test length | 200,000 cycles with cheesecloth changed |
| | every 50,000 cycles |
| Environmental Conditions | 23° C. with 50% relative humidity |
| Passing metric | >100 degree water contact angle |

Static Water Contact Angle

Water contact angle measurements were performed using a Kruss goniometer (DSA100) equipped with ADVANCE software and the sessile drop mapping plugin. The plugin was used to automate the deposition of 2 pL droplets of water in a 10×10 array evenly distributed across a 50 mm×50 mm square sample. The distance between droplets was 5 mm. Once completed, the data was exported and the heat maps were made using Origin. The average water contact angle refers to the water contact angle averaged over the 100 droplets in the 10×10 array distributed across the 50 mm×50 mm square sample.

Surface Tension

Surface tension measurements were performed using a K100C force tensiometer apparatus manufactured by Kruss. The plate method according to the Wilhelmy approach was employed for the measurements. According to this approach, the force acting on an optimally wettable platinum plate, which is immersed vertically in the liquid, is measured.

Coefficient of Friction (CoF)

The coefficient of friction CoF was measured according to standard test method ASTM D1894. The abradant was copy machine paper having a size of 10 mm by 10 mm. The stroke length was 25 mm, the taber speed was 30 rpm, and the weight was 687 grams of force.

2 Surface Reflectance

The 2-surface reflectance measurement was performed using a CM700D integrating sphere spectrophotometer from Konica Minolta. 2-surface means the measured reflected light is from the first and second surface of the substrate under test.

### EXAMPLES

The embodiments of the coated articles and the methods for producing the coated articles described herein will be further clarified by the following examples.

### Example 1 Inkjet Printing the ETC Coating Composition

In Example 1, a coated article comprising an ETC coating composition was prepared through inkjet printing. The substrate was CORNING® GORILLA® glass manufactured and sold by Corning Incorporated. The polymer was OPTOOL™ UD509 silane functionalized PFPE available from Daikin Chemical Europe GmbH, which included the polymer dispersed in a solvent (3M® HFE 7200 solvent in Table 1). The polymer, as received, was diluted with FC-40 solvent from Table 1 to a concentration of 0.12 vol. % of the polymer in the solvent (combination of the 3M® HFE 7200 solvent from the as-received polymer and the FC-40 added for dilution). A SAMBA® 12 nozzle inkjet printhead cartridge from FUJIFILM® Dimatix was used in conjunction with an LP-50 industrial inkjet printing system from SUSS MicroTec to print the ETC coating composition onto the substrate. The inkjet printhead and inkjet printing system was able to print viscosities of the ETC coating compositions provided in Table 2. Stable inkjetting was observed using the standard Dimatix waveform and with a peak voltage of 18 V. The average droplet volume was of the inkjet droplets was found to be around 3 pL. Referring now to FIG. 11, a microphotograph of the printed substrate of Example showing individual droplets of the ETC coating composition printed with the inkjet printing system of Example 1 is shown. Reference number 1102 identifies the individual droplets of ETC coating composition printed on the surface of the substrate. Reference number 1104 refers to reference lines provide by the imaging device.

### Example 2 Print Resolution Versus Coating Performance

In Example 2, the inkjet print resolution was varied and the performance of the ETC coatings were evaluated to assess the amount of ETC coating composition is needed to achieve complete coverage of the substrate. In Example 2, solid squares of the ETC coating composition described in Example 1 were printed onto the following: 1) a plasma treated glass substrate having a silica cap layer applied to the surface, and 2) a glass substrate coated with an AR coating. The glass substrate was the same as in Example 1. Printed squares measured 50 mm by 50 mm. The print resolution (dots per inch (dpi)) of the squares was varied to assess the amount of ETC needed to achieve complete coverage. The squares were printed with the inkjet printing system of Example 1 using the standard waveform and voltage of example 1, which produced an average droplet volume of about 3 pL. Each of the samples were then cured at 150° C. for 30 min and inspected for visible ETC haze (caused by excess, unbound material). Although no haze could be detected, half of the samples were manually wiped with a cloth to simulate current manufacturing procedures for the ETC coating.

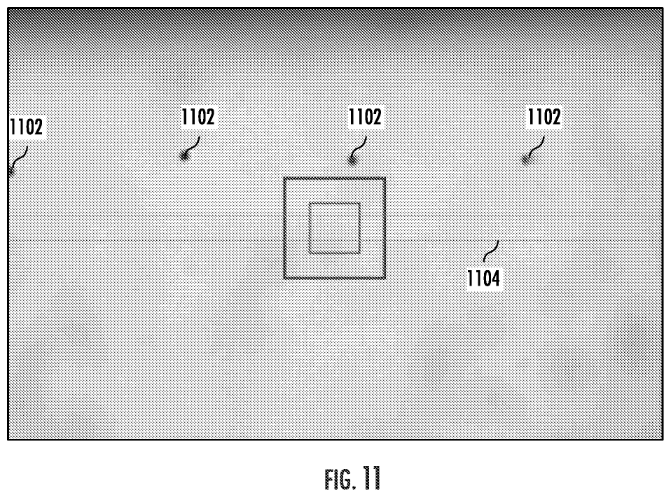

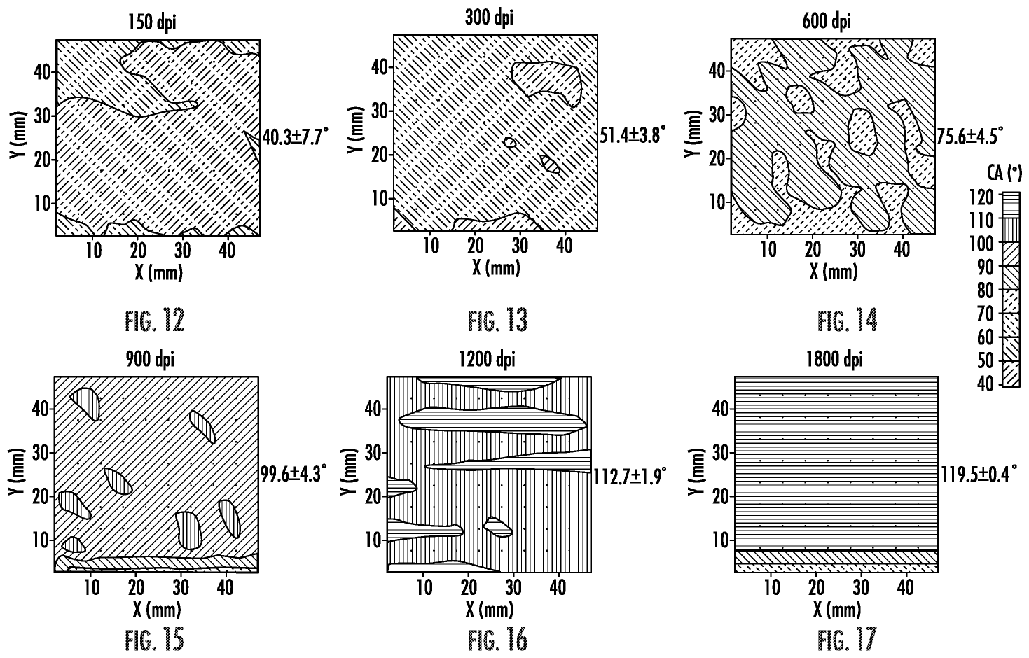

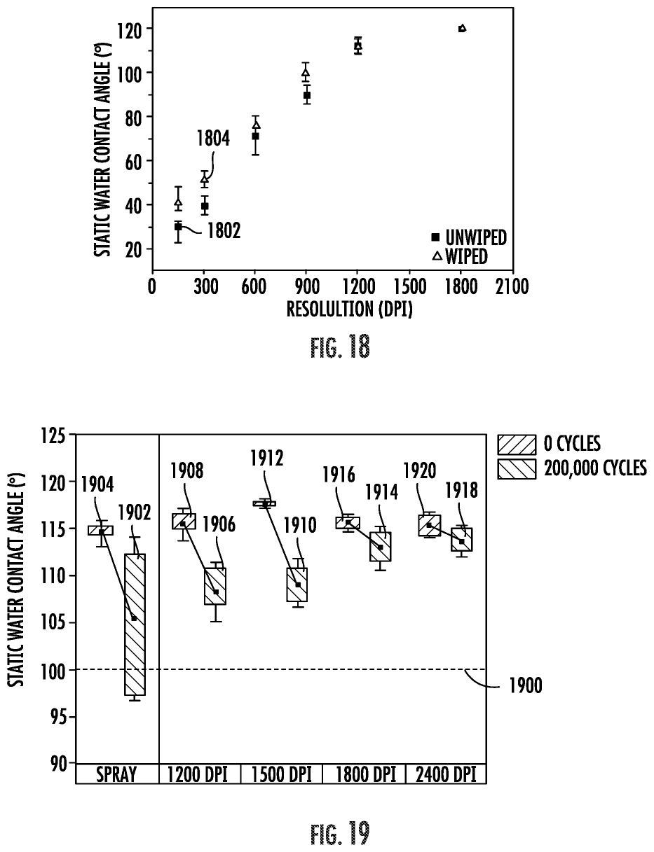

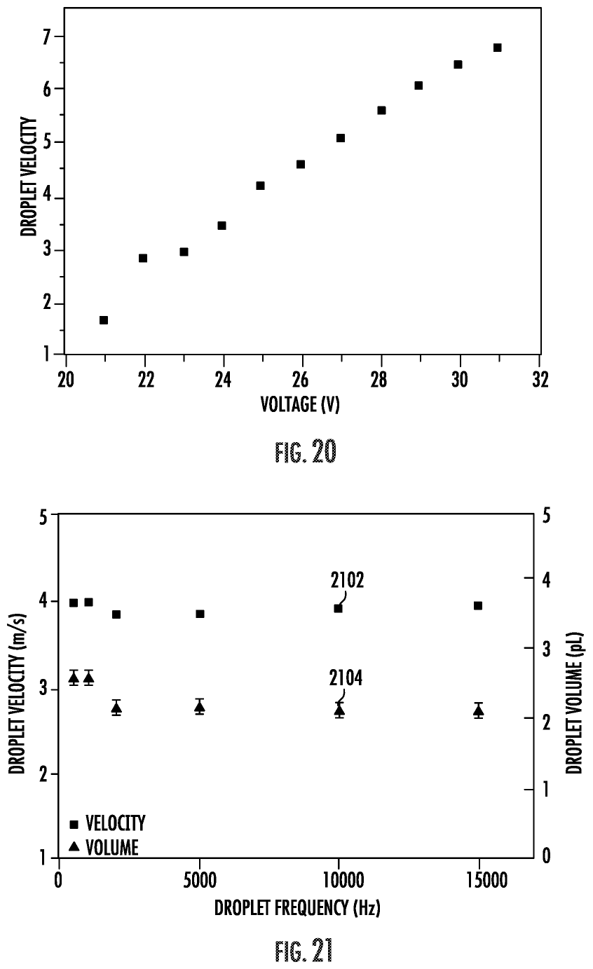

Static water contact angle maps were performed on each of the 50 mm×50 mm square printed samples to determine both hydrophobicity and uniformity. The static water contact angle maps for print resolutions of 150 dpi, 300 dpi, 600 dpi, 900 dpi, 1200 dpi, and 1800 dpi are shown in FIGS. 12-17. As shown each one of FIGS. 12-16, the inkjet printing process produces consistent results across each individual sample, meaning that for each sample, the static water contact angle is consistent across the entire 50 mm×50 mm area. As shown in FIGS. 12-14, inkjet print resolutions of 150 dpi, 300 dpi, and 600 dpi produced static water contact angles less than 100 degrees, indicating incomplete coverage of the surface of the substrate. As previously discussed herein, the coverage can be increased for resolutions of 150 dpi to 600 dpi by increasing the droplet size, printing multiple droplets per pixel, or printing a second layer on top of the first layer. For resolutions of 900 dpi, 1200 dpi, and 1800 dpi (FIGS. 15-17, respectively), the static water contact angle was above 100 degrees, indicating acceptable coverage of the surface of the substrate with the ETC coating.

Referring now to FIG. 18, the average static water contact angles (y-axis) as a function of inkjet print resolution (x-asix) is graphically depicted. In FIG. 18, reference number 1802 (black squares) indicates the static water contact angles for unwiped coated articles, and reference number 1804 (open triangles) indicates the static water contact angles for the wiped samples. At low resolution (low dpi of 150 dpi-900 dpi), the ETC coating is not fully covering the surface of the substrate, resulting in a lower static water contact angle. As the dpi increases, the surface coverage by the ETC coating increases, leading to increasing static water contact angles. The contact angle increases linearly between 150 dpi and about 1200 dpi. Between 1200 dpi and 1800 dpi, full coverage of ETC coating over the surface of the substrate was achieved, as shown by the static water contact angle levelling out between 1200 dpi and 1800 dpi. Any additional ETC coating composition printed at higher dpi is expected to result in “excess” or “unbound” ETC coating material. This unbound material will have little effect on the static water contact angle, but may alter the performance of the ETC coating. Comparison of the unwiped samples 1802 and wiped samples 1804 find that, at the lower resolution (dpi), the wiped samples 1804 demonstrate greater static water contact angles compared to the unwiped samples 1802 printed at the same inkjet print resolution. Without being bound by any particular theory, it is believed that this is likely due to redistribution of the ETC coating material during wiping. At lower dpi, it is believed that the wiping can result in an increase in coverage of the ETC coating across the surface of the substrate and therefore an increase in contact angle. At higher resolution (greater dpi), since the coverage of the ETC coating is already high, the wiping does not lead to a significant change in static water contact angle.

### Comparative Example 3: Spray Coated ETC Coating

For Comparative Example 3, a coated article was prepared with a spray coated ETC coating for purposes of comparison. For Comparative Example 3, the substrate was the same glass substrate used for Example 1. For Comparative Example 3, the glass substrate was first coated with a PVD AR coating on the surface of the glass substrate. The PVD AR coating was an AR coating suitable for automotive display applications. Then, an ETC spray coating composition was prepared and spray coated onto the outer surface of the PVD AR coating. The ETC spray coating composition included the same polymer (OPTOOL™ UD509 silane functionalized PFPE available from Daikin Chemical Europe GmbH). The solvent used for the ETC spray coating composition was 3M™ HFE7200 hydrofluoroether, which had a viscosity of 0.6 cP, which is in the range suitable for the spray coating operation. The ETC spray coating composition was sprayed onto the surface of the substrate using the normal manufacturing scale spray coating equipment, and then cured at 150° C. for 30 min.

### Example 4 Durability of Inkjet Printed ETC Coatings

In Example 4, ETC coatings were printed on AR coated substrates at different resolutions and then evaluated for durability through cheesecloth abrasion and static water contact angle testing. For Example 4, the substrate was the same glass substrate used for Comparative Example 3 and described in Example 1. As with Comparative Example 3, the glass substrate for Example 4 was first coated with a PVD AR coating on the surface of the glass substrate. The PVD AR coating was the same as used in Comparative Example 3. The ETC coating for Example 4 was the same as discussed in Example 1. The ETC coating composition was inkjet printed onto the AR coated glass substrate at different resolutions using the inkjet printing system described in Example 1. Because the pristine ETC surface must have a water contact angle of >1100, only samples with dpi>1200 were printed. Samples were printed at 1200 dpi (4A), 1500 dpi (4B3), 1800 dpi (4C), and 2400 dpi (4D3).

The ETC coated samples of Example 4 and the spray coated ETC samples of Comparative Example 3 were then cheesecloth abraded using the methods disclosed herein and the testing conditions provided in Table 3. Good performance was found for all the inkjet printed samples of Example 4. Additionally, for the abraded samples of Example 4, the inkjet printed ETC coating exhibited less deviation (e.g., tighter tolerance) in the static water contact angle compared to the abraded samples of Comparative Example 3.

TABLE 4

| | | | | | Abraded | | |
|---|---|---|---|---|---|---|---|
| | | Non-Abraded | | | (cheesecloth 200,000 cycles) | | |
| | | | Average | | | Average | |
| | | | Static | | | Static | |
| | | Ref. | Water | | Ref. | Water | |
| | Print | No. | Contact | | No. | Contact | |
| | Resolution | FIG. | Angle | Tolerance | FIG. | Angle | Tolerance |
| Example | (dpi) | 19 | (degrees) | (degrees) | 19 | (degrees) | (degrees) |
| Comp. | — | 1904 | 114.4 | +/−1.4 | 1902 | 105.3 | +/−8.6 |
| Ex. 3 | | | | | | | |
| 4A | 1200 | 1908 | 115.4 | +/−1.8 | 1906 | 108.1 | +/−3.1 |
| 4B | 1500 | 1912 | 117.4 | +/−0.3 | 1910 | 109.0 | +/−2.6 |
| 4C | 1800 | 1916 | 115.4 | +/−0.8 | 1914 | 112.7 | +/−2.3 |
| 4D | 2400 | 1920 | 115.1 | +/−1.2 | 1918 | 113.4 | +/−1.3 |

### Example 5—Multiple Droplets Per Pixel

For Example 5, the standard waveform for the inkjet printhead described in Example 1 was modified to demonstrate the ability to print multiple droplets of the ETC coating composition per pixel and to investigate the effects of voltage and frequency on droplet velocity and droplet volume of the printed droplets of the ETC coating composition. For Example 5, the inkjet printing system was a SAMBA® G3L printhead having 2048 print nozzles a native resolution of 1200 dpi, a native droplet volume of 2.4 pL, a largest droplet volume of 10 pL, a viscosity range of 4-8 cP, and capable of firing frequencies of greater than 100 kHz. The substrate and the ETC coating compositions were the same as those in Example 1.

For Example 5, the waveform for the inkjet printing system was modified to print multiple droplets of the ETC coating composition per pixel. Referring again to FIG. 7, the total volume of the ETC coating composition applied to the substrate (y-axis) as a function of the number of droplets of the ETC coating composition per pixel (x-axis) is schematically depicted. As shown in FIG. 7, the volume of ETC coating composition per pixel is proportional to the number of droplets per pixel. FIG. 7 also demonstrates that up to seven droplets per pixel can be jetted without substantially effecting the volume of the ETC coating composition per droplet. For instance, the total volume for 7 droplets is 15.1+/−0.3 pL, which is about equal to 7 times the volume for a single droplet, which is 2.2+/−0.1 pL.

Additionally, in Example 5, the voltage of the inkjet printing system was varied to assess the greatest droplet velocities achievable without satellite formation. Satellite formation refers to the formation of secondary droplets or mist during jetting of a single droplet and can influence the clarity of the printing. The voltage was increased from 21 volts (V) to 31 volts, and the corresponding droplet velocity was ascertained using a JetXpert 3D drop analysis system from Image Expert. Table 5 and FIG. 20 provide the data on the droplet velocity (y-axis) as a function of voltage (x-axis) for Example 5. The voltage was able to be increased up to 31 volts and a droplet velocity of 6.7+/−0.02 meters per second (m/s) without formation of satellite droplets.

TABLE 5

| Voltage (V) | Droplet Velocity (m/s) |
|---|---|
| 21 | 1.7 +/− 0.01 |
| 22 | 2.8 +/− 0.03 |
| 23 | 3.0 +/− 0.01 |
| 24 | 3.4 +/− 0.01 |
| 25 | 4.2 +/− 0.07 |
| 26 | 4.6 +/− 0.03 |
| 27 | 5.0 +/− 0.01 |
| 28 | 5.5 +/− 0.01 |
| 29 | 6.0 +/− 0.01 |
| 30 | 6.4 +/− 0.01 |
| 31 | 6.7 +/− 0.02 |

Finally, in Example 5, the waveform of the inkjet printing system was modified to print droplets of the ETC coating composition at various firing frequencies from 500 Hertz (Hz) to 15,000 Hz. The droplet volume and droplet velocity were evaluated using the JetXpert 3D drop analysis system. Above 15,000 Hz, the 3D drop analysis system was unable to distinguish between individually jetted droplets. Very little change in the droplet volume and droplet velocity were observed with increasing firing frequency. Table 6 and FIG. 21 provide the data on the droplet velocity and droplet volume for the droplets inkjet printed with increasing firing frequency. As shown in Table 6 and FIG. 21, the droplet velocity (ref no. 2102) and the droplet volume (ref no. 2104) were found to be relatively constant with increasing firing frequency.

TABLE 6

| Firing Frequency (Hz) | Droplet Volume (pL) | Droplet Velocity (m/s) |
|---|---|---|
| Reference number | 2104 | 2102 |
| in FIG. 21 | | |
| 500 | 2.6 +/− 0.1 | 4.0 +/− 0.02 |
| 1000 | 2.6 +/− 0.1 | 4.0 +/− 0.03 |
| 2000 | 2.2 +/− 0.1 | 3.8 +/− 0.01 |
| 5000 | 2.2 +/− 0.1 | 3.8 +/− 0.01 |
| 10000 | 2.1 +/− 0.1 | 3.9 +/− 0.01 |
| 15000 | 2.1 +/− 0.1 | 3.9 +/− 0.01 |

### Example 6: Tuning Water Contact Angle and CoF

In Example 6, the water contact angle and Coefficient of Friction (CoF) of the surface of the coated article were tuned by changing the print resolutions. In Example 6, the substrate was the same as in Example 1. The substrates were plasma treated prior to printing. The ETC coating composition was the same as described in Example 1. The ETC coating composition was inkjet printed onto the surface of the substrate with the inkjet printhead cartridge of Example 1, which was a SAMBA® 12 nozzle inkjet printhead cartridge from FUJIFILM® Dimatix. The ETC coating composition was inkjet printed with the native droplet volume of 2.4 pL. The waveform used for inkjetting was the standard Dimatix SAMBA® waveform with a peak voltage of 25 V. The cartridge was used at room temperature and the substrate was not heated. In Example 6, the substrates were printed at various print resolutions (dpi). After printing, the ETC coating composition was cured at 150° C. for 30 min to form the coated articles having the ETC coating on the surface of the substrate. No wiping was performed after curing.

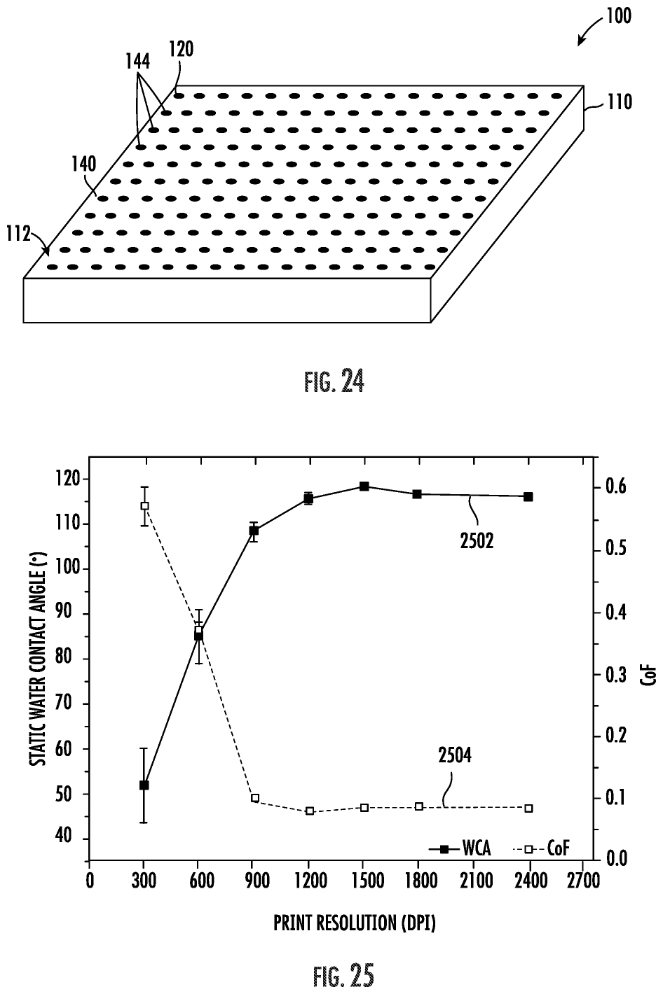

The coated articles of Example 6 were evaluated for water contact angle, CoF, and 2 surface reflectance, according to the methods described herein. The results for the water contact angle (WCA), CoF, and 2 Surface Reflectance are provided below in Table 7. For comparison purposes, the spray coated article of Comparative Example 3 was also evaluated for WCA, CoF, and 2 surface reflectance. Additionally, FIG. 25 graphically depicts the water contact angle 2502 (left y-axis) and CoF 2504 (right y-axis) as a function of print resolution (axis) for the coated articles of Example 6.

TABLE 7

| | | | | 2 Surface |
|---|---|---|---|---|
| | | | | Reflectance |
| Sample | DPI | WCA (°) | CoF | (%) |
| 6A | 300 | 51.9 ± 8.6 | 0.57 ± 0.03 | 7.92 |
| 6B | 600 | 84.9 ± 6.1 | 0.37 ± 0.01 | 7.94 |
| 6C | 900 | 108.2 ± 2.1 | 0.1 ± 0.01 | 7.94 |
| 6D | 1200 | 115.6 ± 1.2 | 0.08 ± 0.01 | 7.93 |
| 6E | 1500 | 118.3 ± 0.3 | 0.09 ± 0.01 | Not measured |
| 6F | 1800 | 116.9 ± 0.5 | 0.09 ± 0.01 | 7.75 |
| 6G | 2400 | 115.8 ± 1.2 | 0.09 ± 0.01 | Not measured |
| Comp. Ex. 3 | Spray | 114.1 ± 1.9 | 0.08 ± 0.01 | Not measured |
| | Coated | | | |

As shown in Table 7, changing the print resolution of the inkjet printing process at constant droplet volume enables the water contact angle and the CoF to be modified, particularly in the range of print resolution of from 300 dpi to 900 dpi, and even less than 300 dpi. In contrast, the spray coating process is unable to provide the ability to tune the CoF and water contact angle due to the nature of the spray coating. As noted above in Table 7, inkjet printing at a resolution of greater than about 1200 dpi produces a water contact angle that is greater than the water contact angle achieved by spray coating in Comparative Example 3.

Referring now to FIG. 25, an inverse trend was observed between contact angle and CoF as a function of print resolution. It is further noted that the water contact angle and/or the CoF can be further tuned by changing the droplet volume and/or grey level. Additionally, the print resolution had very little impact on the optical performance of the coated articles.

### Example 7: Effect of Increasing Droplet Volume

In Example 7, the influence of increasing the droplet volume on the water contact angle is investigated. For Example 7, the ETC coating composition was inkjet printed using a standard FUJIFILM® Dimatix cartridge, which had a larger native drop volume of 10 pL compared to the printhead used in Example 6. The different printhead of Example 7 required a change to the viscosity of the ETC coating composition. The polymer was OPTOOL™ UD509 silane functionalized PFPE available from Daikin Chemical Europe GmbH, which included the polymer dispersed in a solvent. The polymer was diluted to 0.12 vol. % of the polymer in total solvent. For Example 7, the dilution solvent was a 40:60 mixture of FC-40 and FC-70 perfluorocarbon solvents from Table 1. This mixture of dilution solvents was determined by checking the viscosity of different mixtures of FC-40 and FC-70, as shown in FIG. 3. This 40:60 mixture was determined to be optimal for inkjetting in Dimatix cartridges as well as with Konica Minolta production inkjet heads. The waveform used for inkjetting was the standard Dimatix waveform with a peak voltage of 25 V. Following printing, the ETC coating composition was cured at 150° C. for 30 min to form the coated articles having the ETC coating on the surface of the substrate. No wiping was performed after curing.

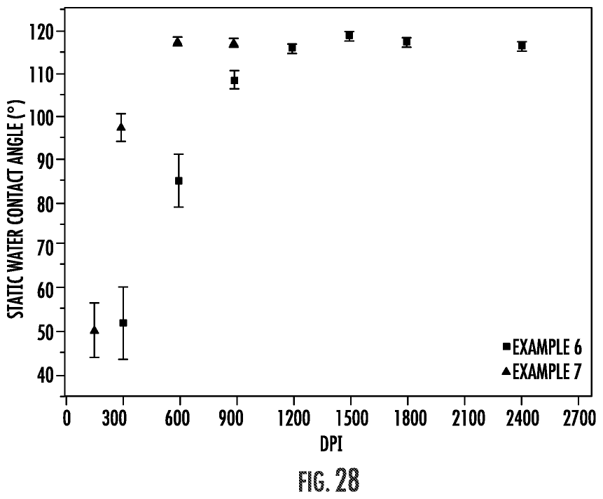

The coated articles of Example 7 were subjected to static water contact angle measurements. Referring now to FIG. 28, the static water contact angle measurements for the coated articles of Examples 6 and 7 as a function of print resolution are graphically depicted. As shown in FIG. 28, greater water contact angles at lower print resolution were observed for the coated articles of Example 7 compared to the water contact angles for the coated articles of Example 6. Not intending to be bound by any particular theory, it is believed that the greater droplet volume of 10 pL for the printhead in Example 7 formed greater coverage of the surface of the substrate at lower print resolution, resulting in the greater water contact angles at lower print resolution compared to a smaller droplet volume of 3 pL in Example 6.

### Example 8: Effect of Changing Grey Level

In Example 8, the effect of changing the grey level (i.e., the number of droplets per pixel) on the amount of ETC coating composition applied to the surface of the substrate is investigated. As previously discussed, the amount of the ETC coating composition (i.e., polymer and solvent) delivered to the surface of the substrate via inkjet printing can be controlled by changing the print resolution and also by changing the droplet size (e.g., volume or diameter) of the individual droplets. The droplet size can be controlled in a specific printhead by using different grey levels. As an example, the SAMBA® G3L printhead has the ability to print at 7 grey levels, resulting in droplet volumes (in flight) of the ETC coating composition of from 2.5 pL to 11 pL.

In Example 8, the ETC coating composition of Example 1 was printed on the substrate described in Example 1 using the SAMBA® 12 nozzle inkjet printhead cartridge from FUJIFILM® Dimatix, which was used in conjunction with an LP-50 industrial inkjet printing system from SUSS MicroTec, as described in Example 1. In Example 8, the ETC coating composition was inkjet printed at various print resolutions of from 500 dpi to 1200 dpi. At each print resolution, the ETC coating composition was inkjet printed at grey levels of from 1 to 7 (i.e., from 1 to 7 individual droplets per pixel).

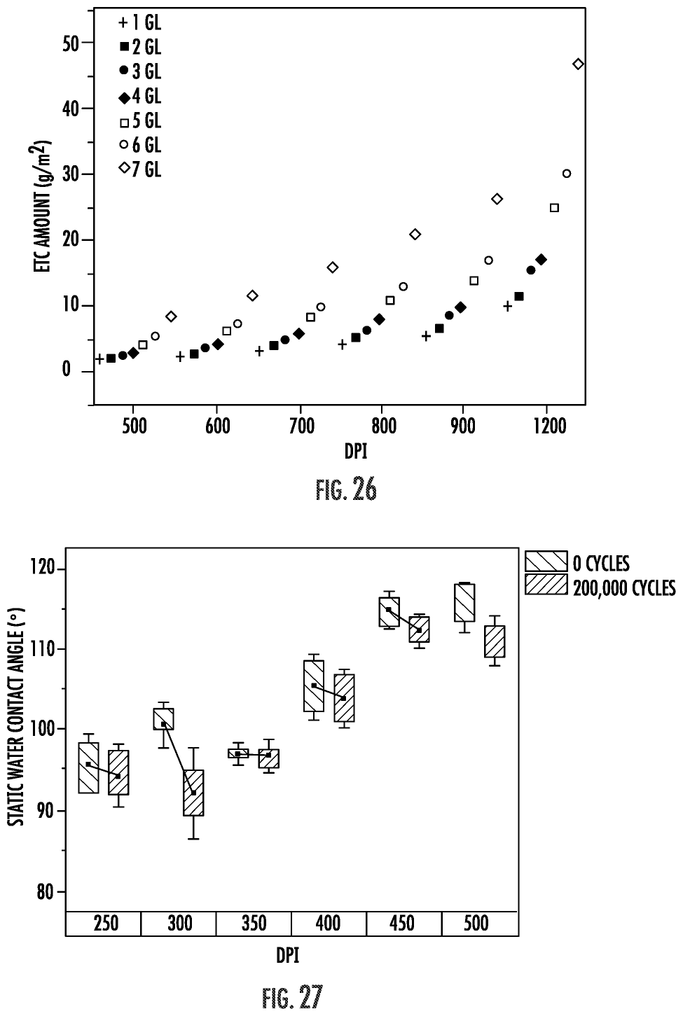

Referring now to FIG. 26, at each print resolution, increasing the grey level increases the total amount of the ETC coating composition applied to the surface of the substrate. FIG. 26 also shows that the amount of ETC coating composition also increases with increasing print resolution. Thus, the amount of ETC coating composition delivered to the surface can be varied by changing both the print resolution and the grey level. The amount of ETC coating composition can also be varied spatially across the surface by printing a pattern of individual droplets spaced apart by uncoated regions instead of a solid block. When printing a pattern of individual dots, the properties of the surface, such as water contact angle, CoF, or both, can thus be varied by changing the print resolution, the grey level, or both.

### Example 9: Durability of ETC Coating Applied at Low Print Resolution

In Example 9, the durability of the ETC coating produced by inkjet printing the ETC coating composition at low print resolutions of less than or equal to 500 dpi was investigated. In Example 9, the substrate was CORNING® GORILLA® glass manufactured and sold by Corning Incorporated and having a silica cap layer applied to the surface of the glass. The ETC coating composition and the inkjet printing system was the same as described in Example 1. In Example 9, the ETC coating composition was inkjet printed at print resolutions of from 250 dpi to 500 dpi. Following printing, the ETC coating composition was cured at 150° C. for 30 min to form the coated articles having the ETC coating on the surface of the substrate. No wiping was performed after curing.

The average water contact angle for each of the coated articles of Example 9 was determined according to the methods described herein. Then, each of the coated articles of Example 9 was abraded with cheesecloth for 200,000 cycles according to the methods described herein and then re-evaluated for average water contact angle. Referring now to FIG. 27, the average water contact angle for print resolutions of from 250 dpi to 400 dpi were less than 110 degrees indicating the print resolution resulting in a pattern of a plurality of individual dots of the ETC coating spaced apart by uncoated regions. Further, FIG. 27 shows that ETC coatings inkjet printed at low resolution less than or equal to 500 dpi are also very durable and show an average water contact angle that changes by less than 10 degrees following abrading the surface with cheesecloth through 200,000 cycles.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of applying an easy-to-clean (ETC) coating on a substrate, the method comprising:
providing the substrate having at least one surface, wherein the substrate comprises a glass substrate or glass ceramic substrate;
preparing an ETC coating composition comprising at least one polymer and a solvent, wherein the viscosity of the ETC coating composition is from 2 cP to 30 cP;
inkjet printing the ETC coating composition onto the at least one surface of the substrate; and
curing the ETC coating composition to produce the ETC coating.

2. The method of claim 1, wherein the at least one polymer of the ETC coating composition comprises a fluorinated material with one or more silane moieties.

3. The method of claim 1, wherein the ETC coating composition comprises from 0.08 vol. % to 20 vol. % of the at least one polymer based on the total weight of the ETC coating composition.

4. The method of claim 1, wherein the solvent comprises one or more of a fluoroether solvent, a hydrofluoroether solvent, a perfluorocarbon solvent, a glycol, a glycol ether, a glycol ester, an alcohol, a hydrocarbon solvent, or combinations of these.

5. The method of claim 1, wherein the solvent has a viscosity of from 1.2 cP to 24 cP.

6. The method of claim 1, wherein the solvent comprises a plurality of different solvents, each of the solvents having a different viscosity, wherein the ETC coating composition comprising the plurality of different solvents has a viscosity of from 4 cP to 24 cP.

7. The method of claim 1, wherein the ETC coating composition has a viscosity of from 4 cP to 18 cP.

8. The method of claim 1, wherein the at least one surface is a bare or textured surface of the substrate or wherein the at least one surface comprises an outer surface of an optical coating applied to the substrate.

9. The method of claim 1, wherein the substrate is a continuous ribbon of glass or glass ceramic and the method further comprises, after curing the ETC coating, cutting the continuous ribbon of glass or glass ceramic into individual articles.

10. The method of claim 1, wherein the ETC coating composition comprises a viscosity modifier, wherein the viscosity modifier comprises a non-functionalized perfluoropolyether (PFPE), wherein the non-functionalized PFPE has an average molecular weight of from 1500 grams per mole to 2200 grams per mole.

11. The method of claim 10, wherein the ETC coating composition comprises from 1 vol. % to 50 vol. % viscosity modifier based on the total volume of the ETC coating composition.

12. The method of claim 1, wherein the ETC coating exhibits a static water contact angle of greater than 110 degrees immediately following curing.

13. The method of claim 1, wherein the ETC coating has a thickness of from 2 nm to 10 nm.

14. The method of claim 1, comprising inkjet printing the ETC coating composition onto the at least one surface of the substrate with an inkjet printing system.

15. The method of claim 1, wherein inkjet printing the ETC coating composition comprises successively depositing a plurality of individual droplets onto the at least one surface of the substrate, wherein an average size of the plurality of individual droplets is from 2 pL to 100 pL.

16. The method of claim 1, wherein the droplet volume of 99% of the plurality of individual droplets is within 5% of the average droplet volume of the plurality of individual droplets.

17. The method of claim 1, comprising changing a thickness of the ETC coating in one or more regions of the at least one surface of the substrate, wherein changing the thickness of the ETC coating comprises one or more of the following:
modifying an average droplet size of the plurality of individual droplets of the ETC coating composition;
modifying a resolution (pixels per inch) of the inkjet printing;
modifying a number of individual droplets of the ETC coating composition printed per pixel;
inkjet printing one or more subsequent layers of the ETC coating compositions; or
combinations of these.

18. A coated article comprising:
a substrate comprising a glass or a glass ceramic and having at least one surface; and
an ETC coating bonded to the at least one surface of the substrate, wherein the ETC coating comprises a plurality of cured droplets of an ETC coating composition deposited onto the at least one surface by inkjet printing.

19. The coated article of claim 18, wherein, over a 50 mm by 50 mm square of the ETC coating over which the average thickness is calculated, the ETC coating has an average static water contact angle of greater than 100 degrees with a tolerance of less than or equal to +/−4 degrees.

20. The coated article of claim 18, wherein the coated article comprises:
one or more first regions comprising a first thickness of the ETC coating; and
one or more second regions comprising a second thickness of the ETC coating, wherein the second thickness is different from the first thickness, wherein:
the first thickness of the ETC coating in 99% of the one or more first regions is within 5% of an average first thickness of the one or more first regions; and
the second thickness of the ETC coating in 99% of the one or more second regions is within 5% of an average second thickness of the one or more second regions.
